(19) United States
(12) Patent Application Publication
(10) Pub. No.: US 2022/0174960 A1
(43) Pub. Date: Jun. 9, 2022

(54) AGRICULTURAL COMPOSITIONS AND METHODS RELATED THERETO

(71) Applicants: Stephen Reynold FORD, Pukekohe2120 (NZ); Michael TREADWELL, Pukekohe (NZ); Ankita SIGDEL, Pukekohe (NZ); Bernard KIMBLE, Pukekohe (NZ); ECOLIBRIUM BIOLOGICALS HOLDINGS LIMITED, Pukekohe (NZ)

(72) Inventors: Stephen Reynold FORD, Pukekohe (NZ); Michael TREADWELL, Pukekohe (NZ); Ankita SIGDEL, Pukekohe (NZ); Bernard KIMBLE, Pukekohe (NZ)

(21) Appl. No.: 17/438,164

(22) PCT Filed: Dec. 20, 2019
(86) PCT No.: PCT/NZ2019/050161

§ 371 Date: Sep. 10, 2021

(30) Foreign Application Priority Data
Dec. 21, 2018 (NZ) 749596

(51) Int. Cl. A01N 63/30; A01N 25/04; A01N 31/06; A01N 43/16; A01P 13/00

(52) U.S. Cl. CPC A01N 63/30; A01N 25/04; A01P 13/00; A01N 43/16; A01N 31/06

(57) ABSTRACT

The invention relates to compositions for use in agriculture and horticulture, wherein the compositions comprise one or more carbohydrates and one or more active agents selected from the group comprising one or more phytotoxins, one or more nutrients, and one or more organic molecules. Methods of preparing and using the compositions are also provided, for example in the control of unwanted plants, to promote the growth of one or more desired plants, and/or to minimise environmental impacts stemming from the widespread use of large quantities and concentrations of agricultural chemicals.

### TECHNICAL FIELD

The invention relates to compositions for use in agriculture and horticulture, wherein the compositions comprise one or more carbohydrates and one or more active agents selected from the group comprising one or more phytotoxins, one or more nutrients, and one or more organic molecules. Methods of preparing and using the compositions are also provided, for example in the control of unwanted plant pathogens and/or to minimise environmental impacts stemming from the widespread use of large quantities and concentrations of agricultural chemicals.

### BACKGROUND OF THE INVENTION

The following includes information that may be useful in understanding the present inventions. It is not an admission that any of the information provided herein is prior art, or relevant, to the presently described or claimed inventions, or that any publication or document that is specifically or implicitly referenced is prior art. Any discussion of the prior art throughout the specification should in no way be considered as an admission that such prior art is widely known or forms part of the common general knowledge in the field.

Foliar application of agricultural compositions to plants is in many circumstances the most straightforward means by which agriculturally and horticulturally useful agents can be administered to plants and their surroundings. For example, foliar application of nutrients or pesticides is a significant part of most crop management strategies. Foliar application is advantageous in that spraying technologies are well-developed, easily implemented, and cost- and time-effective, while usually less disruptive to the plant and/or its surroundings compared to methods that rely on administration to the soil or substrate.

However, as will be appreciated, uptake into and redistribution within the plant of active agents that have been applied via the plant foliage remains a challenge. Frequently, plant leaves and stems have waxy cuticles and selective tissues that are impermeable to externally applied compounds. Similarly, targeted translocation of active agents within the plant, for example via the phloem, remains problematic.

There remains a need for a way in which active agents that have been applied via plant foliage can be translocated to other parts of the plant, such as the root system.

It is therefore an object of the invention to provide compositions for foliar application that comprise one or more active agents selected from the group comprising one or more phytotoxins, one or more nutrients, and one or more organic molecules, and one or translocating carbohydrates, or to at least provide a useful alternative to existing foliar compositions, or to at least provide the public with a useful choice.

### SUMMARY OF THE INVENTION

In a first aspect the invention relates to an agriculturally acceptable composition comprising, consisting essentially of, or consisting of one or more carbohydrates, one or more active agents selected from the group comprising one or more phytotoxins, one or more nutrients, and one or more organic molecules, optionally one or more surfactants, and optionally one or more wounding agents.

In one embodiment, the composition is an agriculturally acceptable composition comprising, consisting essentially of, or consisting of
i) one or more carbohydrates;
ii) one or more active agents selected from the group comprising one or more phytotoxins, one or more nutrients, and one or more organic molecules; and
iii) one or more surfactants.

In one embodiment, the composition comprises, consists essentially of, or consists of
i) one or more carbohydrates;
ii) one or more active agents selected from the group comprising one or more phytotoxins, one or more nutrients, and one or more organic molecules; and
iii) one or more wounding agents.

In one embodiment, the composition comprises, consists essentially of, or consists of
i) one or more carbohydrates;
ii) one or more active agents selected from the group comprising one or more phytotoxins, one or more nutrients, and one or more organic molecules;
iii) one or more surfactants; and
iv) one or more wounding agents.

In another aspect, the invention relates to a method of promoting the growth of a plant or conferring a benefit to a plant, the method comprising contacting the plant with a composition as described herein, wherein the active agent is selected from the group comprising one or more organic molecules, or one or more nutrients including one or more fertilisers, or one or more minerals or trace elements.

In various embodiments, the benefit comprises increased resistance to one or more environment& conditions, such as one or more adverse environmental conditions. In various embodiments, the benefit is an ability to grow in high salt conditions. In one embodiment, the benefit is an ability to grow in arid conditions or in the presence of reduced water availability, for example, compared to equivalent plants that have not been contacted with the composition.

In one embodiment, the benefit is an improved ability to absorb one or more nutrients or fertilizers. In one embodiment, the benefit is an improved ability to support one or more beneficial microbes, such as one or more rhizobacteria.

In another aspect, the invention relates to a method for producing a phytobeneficial composition, the method comprising:

combining the one or more carbohydrates with an effective amount of one or more phytobeneficial active agents selected from the group comprising one or more organic molecules, or one or more nutrients such as one or more fertilisers, one or more minerals or trace elements, optionally together with one or more agriculturally-acceptable carriers, thereby to provide a phytobeneficial composition.

In another aspect, the invention relates to a method of controlling one or more plants or plant populations. The method generally involves contacting the plant, plant population, or plant surroundings with a phytotoxically-effective amount of a composition comprising one or more phytotoxin as described herein. Such methods may be used to kill or reduce the numbers of target plants in a given area, or may be prophylactically applied to an environmental area to prevent plant growth.

The present invention further relates to a method for controlling one or more plants, generally one or more undesired plants, the method comprising applying to a plant or its surroundings a composition comprising one or more phytotoxin as described herein, optionally together with one or more agriculturally-acceptable active agents.

In still a further aspect, the invention relates to a method for producing a phytotoxic composition, the method comprising:

combining the one or more carbohydrates with a phytotoxically-effective amount of one or more phytotoxins and one or more wounding agents, optionally together with one or more surfactants,

thereby to provide a phytotoxically-effective composition.

In another aspect the invention relates to an agriculturally acceptable concentrated composition suitable for dilution prior to application, and comprises
i) at least about 5% w/w one or more carbohydrates;
ii) at least about 5% w/w one or more surfactants;
iii) at least about 5% w/w one or more wounding agents; and
iv) optionally at least about 5% w/w humectants.

In one embodiment, the concentrated composition suitable for dilution prior to application comprises
i) at least about 10% w/w one or more carbohydrates;
ii) at least about 10% w/w one or more surfactants;
iii) at least about 10% w/w one or more wounding agents; and
iv) optionally at least about 10% w/w humectants.

In various embodiments, the composition is a concentrated composition suitable for dilution prior to application, and comprises

from about 5% w/w to about 50% w/w carbohydrate;

from about 5% w/w to about 30% w/w wounding agent;

from about 5% w/w to about 50% w/w surfactant; and

optionally from about 5% w/w to about 30% w/w humectant.

In one embodiment, the agriculturally acceptable concentrated composition suitable for dilution prior to application is formulated for dilution with one or more active agents selected from the group comprising one or more phytotoxins, one or more nutrients, and one or more organic molecules. In one embodiment, the concentrated composition is formulated for dilution with one or more aqueous solvents and one or more active agents selected from the group comprising one or more phytotoxins, one or more nutrients, and one or more organic molecules.

Any of the embodiments described herein can relate to any of the aspects presented herein.

In various embodiments, the carbohydrate is present in an amount or at a concentration effective to increase uptake and/or translocation of the one or more active agents from the site of application. In one embodiment, the carbohydrate is present in an amount or at a concentration on application that is effective to increase translocation of the one or more active agents substantially throughout the plant. For example, the carbohydrate is present in an amount or at a concentration at application effective to increase systemic distribution of the one or more active agents beyond the systemic distribution achieved in the absence of the carbohydrate.

In various embodiments, the systemic distribution is distribution to the roots. For example, the carbohydrate is present in an amount or at a concentration on application that is effective to increase translocation of the one or more active agents to the roots. For example, the carbohydrate is present in an amount or at a concentration at application effective to increase the amount or concentration of the one or more active agents in the roots beyond the amount or concentration of the one or more active agents in the roots achieved in the absence of the carbohydrate.

Accordingly, in one embodiment, the agriculturally acceptable composition is an agriculturally acceptable composition for application to a plant or its surroundings, the composition comprising, consisting essentially of, or consisting of
i) one or more carbohydrates;
ii) one or more active agents selected from the group comprising one or more phytotoxins, one or more nutrients, and one or more organic molecules; and
iii) optionally one or more surfactants; and
iv) optionally one or more wounding agents;
   wherein the one or more carbohydrates is present in an amount or at a concentration at application to the plant or its surroundings effective to increase systemic distribution of the one or more active agents in the plant beyond the systemic distribution achieved in the absence of the carbohydrate.

Such an amount or concentration is referred to herein as a “translocation-effective” amount or concentration. It will be appreciated that the amount or concentration required to be translocation-effective differs for different carbohydrates, and is readily-determinable, for example using the methods described herein.

In one embodiment, at least a proportion of the one or more of the carbohydrates present in the composition and at least a proportion of the one or more active agents are present as a complex, for example, as an inclusion complex, or are ionically bound.

In one embodiment, one or more of the carbohydrates is a disaccharide. For example, the carbohydrate is selected from the group comprising sucrose, lactulose, lactose, maltose, trehalose, cellobiose, chitobiose, kojibiose, nigerose, isomaltose, sophorose, laminaribiose, gentiobiose, turanose, maltulose, palatinose, gentiobiulose, mannobiose, melibiose, melibiulose, rutinose, rutinulose, and xylobiose.

In another example, the carbohydrate is selected from the group comprising sucrose, lactulose, lactose, maltose, trehalose, cellobiose, and chitobiose. In a further example, the carbohydrate is selected from the group comprising sucrose, lactose, and maltose.

In another embodiment, one or more of the carbohydrates is a monosaccharide. In one embodiment, the monosaccharide is a pentose. In one embodiment, the monosaccharide is a hexose. In one embodiment, the monosaccharide is selected from the group comprising ribose, arabinose, xylose, glucose, fructose, and galactose. For example, the carbohydrate is selected from the group comprising glucose, fructose, and galactose.

In another embodiment, one or more of the carbohydrates is a polysaccharide, a glucan or a cyclodextrin. In one embodiment, the polysaccharide is selected from the group comprising starch, cellulose, pectin, hemicellulose, and a gum.

In one embodiment, the cyclodextrin is alpha-cyclodextrin, beta-cyclodextrin, or gamma-cyclodextrin.

In various embodiments, the phytotoxin is a herbicide. For example, the herbicide is a synthetic herbicide. Many synthetic herbicides are known to those skilled in the art, and are amenable to use in the compositions described herein.

In certain specifically contemplated embodiments, the herbicide is a biological herbicide. For example, the biological herbicide is or is derived from a biological source, such as an organism, including a phytotoxic or phytopathogenic organism, virus, or the like.

In one embodiment, the phytotoxin is a phytotoxic microorganism selected from the group comprising Botrytis spp., Rhizopus spp., Sclerotinia minor, Mucor spp., Erwinia carotovora subsp. caratovora, and Pseudomonas spp., such as Pseudomonas syringae.

In one embodiment, the phytotoxin is a biological herbicide selected from the group comprising one or more phytotoxic agents derived from Botrytis spp., Rhizopus spp., Sclerotinia minor, Mucor spp., Erwinia carotovora subsp. caratovora, and Pseudomonas spp., such as Pseudomonas syringae.

In one embodiment, the phytotoxin is a biological herbicide selected from the group comprising one or more phytotoxic metabolites from Botrytis spp., one or more phytotoxic metabolites from Rhizopus spp., one or more phytotoxic metabolites from Sclerotinia minor, one or more phytotoxic metabolites from Mucor spp., one or more phytotoxic metabolites from Erwinia carotovora subsp. caratovora, and one or more phytotoxic metabolites from Pseudomonas spp., such as Pseudomonas syringae.

In one embodiment, the phytotoxin is one or more phytotoxic metabolites from Botrytis spp., for example one or more phytotoxic metabolites of Botrytis cinerea. For example, the phytotoxin is selected from the group comprising botrydial, botcinic acid, and one or more phytotoxic polyketides.

In one embodiment, the phytotoxin is one or more phytotoxic metabolites from Pseudomonas syringae.

In one embodiment, the phytotoxin is a cellulase.

In various embodiments, the one or more nutrients one or more fertilisers, or one or more minerals or trace elements. In various embodiments, the one or more nutrients is selected from the group comprising nitrogen, magnesium, calcium, boron, potassium, copper, iron, phosphorus, manganese, molybdenum, cobalt, boron, copper, silicon, selenium, nickel, aluminum, chromium and zinc.

In various embodiments, the one or more organic molecules is a phenolic, a polyphenolic, a xanthene or xanthene derivative, In one embodiment, the wounding agent is selected from the group comprising one or more lipolytic enzymes, one or more super wetting agents, one or more abrasives, and one or more fatty acids, such as one or more short chain fatty acids, or one or more medium chain fatty acids. For example, the wounding agent is one or more short or medium chain fatty acids.

In various embodiments, the wounding agent is selected from the group comprising acetic acid, Butyric acid (Butanoic acid), Valeric acid (Pentanoic acid), Caproic acid (Hexanoic acid), Enanthic acid (Heptanoic acid), Caprylic acid (Octanoic acid), Pelargonic acid (Nonanoic acid), Capric acid (Decanoic acid), Undecylic acid (Undecanoic acid), Lauric acid (Dodecanoic acid), Tridecylic acid (Tridecanoic acid), Myristic acid (Tetradecanoic acid), and Pentadecylic acid (Pentadecanoic acid), including a combination of any two or more thereof.

In one embodiment, the wounding agent is caprylic acid, pelargonic acid, capric acid, or a combination of any two or more thereof. For example, the wounding agent is a combination of caprylic acid and capric acid. In another example, the wounding agent is pelargonic acid.

In one embodiment, the surfactant is an anionic surfactant. In another embodiment, the surfactant is a non-ionic surfactant. In still another embodiment, the surfactant is a cationic surfactant.

In one embodiment, the non-ionic surfactant is selected from the group comprising ethoxylated compounds and alkylpolyglucosides (APGs). For example, the non-ionic surfactant is an alkylpolyglucoside.

In one embodiment, the composition comprises one or more additional actives, such as an agent effective to induce localised acquired resistance in the plant, or an agent effective to induce systemic acquired resistance in the plant. For example, the composition comprises one or more additional agents selected from the group comprising one or more fungal glycoproteins, one or more bacterial proteins, for example flagellin, salicylic acid and its methylated derivative MeSA, jasmonic acid, auxin, pipecolic acid, dehdryoabietinal, azelaic acid, glycerol-3-phosphate, and chitin. For example, the composition comprises chitin.

In various embodiments, including for example as or in ready-to-use formulations, the composition as described herein comprises at least about 0.001%, 0.005, 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1.0, 1.5, or 2% by weight one or more carbohydrates.

In various embodiments, including for example as or in ready-to-use formulations, the composition as described herein is a ready-to-use formulation comprising at least about 0.01 g·L⁻¹, 0.05, 0.1, 0.2, 0.3, 0.4, 0.5, 0.6, 0.7, 0.8, 0.9, 1.0, 1.5, 2, 3, 4, 5, 6, 7, 8, 9, or at least about 10 g·L⁻¹ of one or more carbohydrates.

In various embodiments, for example on application, a composition as described herein comprises at least about 0.01, 0.05, 0.1, 0.2, 0.3, 0.4, 0.5, 0.6, 0.7, 0.8, 0.9, 1.0, 1.1, 1.2, 1.3, 1.4, 1.5, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95 or 100 g/L of one or more carbohydrates, and useful ranges may be selected between any of these values (for example, about 0.01 to about 1.0, about 0.01 to about 10, about 0.01 to about 20, about 0.01 to about 30, about 0.01 to about 40, about 0.01 to about 50, about 0.01 to about 60, about 0.01 to about 70, about 0.01 to about 80, about 0.01 to about 90, about 0.01 to about 100, about 0.1 to about 1.0, about 0.1 to about 10, about 0.1 to about 20, about 0.1 to about 30, about 0.1 to about 40, about 0.1 to about 50, about 0.1 to about 60, about 0.1 to about 70, about 0.1 to about 80, about 0.1 to about 90, about 0.1 to about 100, about 0.7 to about 1.0, about 0.7 to about 10, about 0.7 to about 20, about 0.7 to about 30, about 0.7 to about 40, about 0.7 to about 50, about 0.7 to about 60, about 0.7 to about 70, about 0.7 to about 80, about 0.7 to about 90, or about 0.7 to about 100 g/L).

In various embodiments, such as for example as or in a concentrated formulation, the composition as described herein comprises at least about 1%, 1.5, 2, 2.5, 3, 3.5, 4, 4.5, 5, 0.5.5, 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29, 30, 35, 40, or more than 40% by weight one or more carbohydrates.

In various embodiments, such as for example as or in a concentrated formulation, the composition as described herein comprises from at least about 5% w/w to about 40% w/w one or more carbohydrates, such as from about 10% w/w to about 30% w/w one or more carbohydrates.

In various embodiments, the composition as described herein is a formulation comprising at least about 5 g·L⁻¹, 10, 20, 30, 40, 50, 60, 70, 80, 90, 100, 110, 120, 130, 140, 150, 160, 170, 180, 190, 200, 225, 250, 275, 300, 350, 400, 450, at least about 500, or more than 500 g·L⁻¹ of one or more carbohydrates.

In various embodiments, including for example as or in ready-to-use formulations, the composition as described herein comprises at least about 0.001%, 0.005, 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1.0, 1.5, or 2% by weight one or more active agents selected from the group comprising one or more phytotoxins, one or more nutrients, and one or more organic molecules.

In various embodiments, including for example as or in ready-to-use formulations, the composition as described herein is a ready-to-use formulation comprising at least about 0.01 g·L⁻¹, 0.05, 0.1, 0.2, 0.3, 0.4, 0.5, 0.6, 0.7, 0.8, 0.9, 1.0, 1.5, 2, 3, 4, 5, 6, 7, 8, 9, or at least about 10 g·L⁻¹ of one or more active agents selected from the group comprising one or more phytotoxins, one or more nutrients, and one or more organic molecules.

In various embodiments, for example on application, a composition as described herein comprises at least about 0.01, 0.05, 0.1, 0.2, 0.3, 0.4, 0.5, 0.6, 0.7, 0.8, 0.9, 1.0, 1.1, 1.2, 1.3, 1.4, 1.5, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95 or 100 g/L of one or more active agents selected from the group comprising one or more phytotoxins, one or more nutrients, and one or more organic molecules, and useful ranges may be selected between any of these values (for example, about 0.01 to about 1.0, about 0.01 to about 10, about 0.01 to about 20, about 0.01 to about 30, about 0.01 to about 40, about 0.01 to about 50, about 0.01 to about 60, about 0.01 to about 70, about 0.01 to about 80, about 0.01 to about 90, about 0.01 to about 100, about 0.1 to about 1.0, about 0.1 to about 10, about 0.1 to about 20, about 0.1 to about 30, about 0.1 to about 40, about 0.1 to about 50, about 0.1 to about 60, about 0.1 to about 70, about 0.1 to about 80, about 0.1 to about 90, about 0.1 to about 100, about 0.7 to about 1.0, about 0.7 to about 10, about 0.7 to about 20, about 0.7 to about 30, about 0.7 to about 40, about 0.7 to about 50, about 0.7 to about 60, about 0.7 to about 70, about 0.7 to about 80, about 0.7 to about 90, or about 0.7 to about 100 g/L).

In various embodiments, such as for example as or in a concentrated formulation, the composition as described herein comprises at least about 1%, 1.5, 2, 2.5, 3, 3.5, 4, 4.5, 5, 0.5.5, 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29, 30, 35, 40, or more than 40% by weight one or more active agents selected from the group comprising one or more phytotoxins, one or more nutrients, and one or more organic molecules.

In various embodiments, the composition as described herein is a formulation comprising at least about 5 g·L⁻¹, 10, 20, 30, 40, 50, 60, 70, 80, 90, 100, 110, 120, 130, 140, 150, 160, 170, 180, 190, 200, 225, 250, 275, 300, 350, 400, 450, at least about 500, or more than 500 g·L⁻¹ of one or more active agents selected from the group comprising one or more phytotoxins, one or more nutrients, and one or more organic molecules.

In various embodiments, including for example as or in ready-to-use formulations, the composition as described herein comprises at least about 0.001%, 0.005, 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1.0, 1.5, or 2% by weight one or more phytotoxins.

In various embodiments, including for example as or in ready-to-use formulations, the phytotoxic composition as described herein is a ready-to-use formulation comprising at least about 0.01 g·L⁻¹, 0.05, 0.1, 0.2, 0.3, 0.4, 0.5, 0.6, 0.7, 0.8, 0.9, 1.0, 1.5, 2, 3, 4, 5, 6, 7, 8, 9, or at least about 10 g·L⁻¹ of one or more phytotoxins.

In various embodiments the phytotoxin is obtained or obtainable from Botrytis cinerea comprising at least about 1, 2, 3, 4, 5, 6, 7, 8, 9, 10, 15, 20, 25, 30, 35, 40, 45, or 50, 55, 60, 65, 70, 75, 80, 85, 90, 95 or 99% by weight of botrydial, and useful ranges may be selected between any of these values (for example, about 1 to about 99, about 5 to about 99, about 10 to about 99, about 15 to about 99, about 20 to about 99, about 25 to about 99, about 30 to about 99, about 35 to about 99, about 40 to about 99, about 45 to about 99, about 50 to about 99, about 55 to about 99, about 60 to about 99, about 65 to about 99, about 70 to about 99, about 75 to about 99, about 80 to about 99, about 85 to about 99, or about 90 to about 99% by weight).

It should be understood that any compositions useful herein include compositions obtained or obtainable from one or more Botrytis cinerea strains or variants, such as those grown for commercial viticulture.

In various embodiments, for example on application, a composition as described herein comprises at least about 0.01, 0.05, 0.1, 0.2, 0.3, 0.4, 0.5, 0.6, 0.7, 0.8, 0.9, 1.0, 1.1, 1.2, 1.3, 1.4, 1.5, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95 or 100 g/L of one or more phytotoxins, and useful ranges may be selected between any of these values (for example, about 0.01 to about 1.0, about 0.01 to about 10, about 0.01 to about 20, about 0.01 to about 30, about 0.01 to about 40, about 0.01 to about 50, about 0.01 to about 60, about 0.01 to about 70, about 0.01 to about 80, about 0.01 to about 90, about 0.01 to about 100, about 0.1 to about 1.0, about 0.1 to about 10, about 0.1 to about 20, about 0.1 to about 30, about 0.1 to about 40, about 0.1 to about 50, about 0.1 to about 60, about 0.1 to about 70, about 0.1 to about 80, about 0.1 to about 90, about 0.1 to about 100, about 0.7 to about 1.0, about 0.7 to about 10, about 0.7 to about 20, about 0.7 to about 30, about 0.7 to about 40, about 0.7 to about 50, about 0.7 to about 60, about 0.7 to about 70, about 0.7 to about 80, about 0.7 to about 90, or about 0.7 to about 100 g/L).

In various embodiments, such as for example as or in a concentrated formulation, the phytotoxic composition as described herein comprises at least about 1%, 1.5, 2, 2.5, 3, 3.5, 4, 4.5, 5, 0.5.5, 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29, 30, 35, 40, or more than 40% by weight one or more phytotoxins.

In various embodiments, the phytotoxic composition as described herein is a formulation comprising at least about 5 g·L⁻¹, 10, 20, 30, 40, 50, 60, 70, 80, 90, 100, 110, 120, 130, 140, 150, 160, 170, 180, 190, 200, 225, 250, 275, 300, 350, 400, 450, at least about 500, or more than 500 g·L⁻¹ of one or more phytotoxins.

In various embodiments, including for example as or in ready-to-use formulations, the composition as described herein comprises at least about 0.001%, 0.005, 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1.0, 1.5, or 2% by weight one or more wounding agents.

In various embodiments, including for example as or in ready-to-use formulations, the composition as described herein is a ready-to-use formulation comprising at least about 0.01 g·L⁻¹, 0.05, 0.1, 0.2, 0.3, 0.4, 0.5, 0.6, 0.7, 0.8, 0.9, 1.0, 1.5, 2, 3, 4, 5, 6, 7, 8, 9, or at least about 10 g·L⁻¹ of one or more wounding agents.

In various embodiments, for example on application, a composition as described herein comprises at least about 0.01, 0.05, 0.1, 0.2, 0.3, 0.4, 0.5, 0.6, 0.7, 0.8, 0.9, 1.0, 1.1, 1.2, 1.3, 1.4, 1.5, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95 or 100 g/L of one or more wounding agents, and useful ranges may be selected between any of these values (for example, about 0.01 to about 1.0, about 0.01 to about 10, about 0.01 to about 20, about 0.01 to about 30, about 0.01 to about 40, about 0.01 to about 50, about 0.01 to about 60, about 0.01 to about 70, about 0.01 to about 80, about 0.01 to about 90, about 0.01 to about 100, about 0.1 to about 1.0, about 0.1 to about 10, about 0.1 to about 20, about 0.1 to about 30, about 0.1 to about 40, about 0.1 to about 50, about 0.1 to about 60, about 0.1 to about 70, about 0.1 to about 80, about 0.1 to about 90, about 0.1 to about 100, about 0.7 to about 1.0, about 0.7 to about 10, about 0.7 to about 20, about 0.7 to about 30, about 0.7 to about 40, about 0.7 to about 50, about 0.7 to about 60, about 0.7 to about 70, about 0.7 to about 80, about 0.7 to about 90, or about 0.7 to about 100 g/L).

In various embodiments, such as for example as or in a concentrated formulation, the composition as described herein comprises at least about 1%, 1.5, 2, 2.5, 3, 3.5, 4, 4.5, 5, 0.5.5, 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29, 30, 35, 40, or more than 40% by weight one or more wounding agents.

In various embodiments, the composition as described herein is a formulation comprising at least about 5 g·L⁻¹, 10, 20, 30, 40, 50, 60, 70, 80, 90, 100, 110, 120, 130, 140, 150, 160, 170, 180, 190, 200, 225, 250, 275, 300, 350, 400, 450, at least about 500, or more than 500 g·L⁻¹ of one or more wounding agents.

In various embodiments, including for example as or in ready-to-use formulations, the composition as described herein comprises at least about 0.001%, 0.005, 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1.0, 1.5, or 2% by weight one or more surfactants.

In various embodiments, including for example as or in ready-to-use formulations, the composition as described herein is a ready-to-use formulation comprising at least about 0.01 g·L⁻¹, 0.05, 0.1, 0.2, 0.3, 0.4, 0.5, 0.6, 0.7, 0.8, 0.9, 1.0, 1.5, 2, 3, 4, 5, 6, 7, 8, 9, or at least about 10 g·L⁻¹ of one or more surfactants.

In various embodiments, for example on application, a composition as described herein comprises at least about 0.01, 0.05, 0.1, 0.2, 0.3, 0.4, 0.5, 0.6, 0.7, 0.8, 0.9, 1.0, 1.1, 1.2, 1.3, 1.4, 1.5, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95 or 100 g/L of one or more surfactants, and useful ranges may be selected between any of these values (for example, about 0.01 to about 1.0, about 0.01 to about 10, about 0.01 to about 20, about 0.01 to about 30, about 0.01 to about 40, about 0.01 to about 50, about 0.01 to about 60, about 0.01 to about 70, about 0.01 to about 80, about 0.01 to about 90, about 0.01 to about 100, about 0.1 to about 1.0, about 0.1 to about 10, about 0.1 to about 20, about 0.1 to about 30, about 0.1 to about 40, about 0.1 to about 50, about 0.1 to about 60, about 0.1 to about 70, about 0.1 to about 80, about 0.1 to about 90, about 0.1 to about 100, about 0.7 to about 1.0, about 0.7 to about 10, about 0.7 to about 20, about 0.7 to about 30, about 0.7 to about 40, about 0.7 to about 50, about 0.7 to about 60, about 0.7 to about 70, about 0.7 to about 80, about 0.7 to about 90, or about 0.7 to about 100 g/L).

In various embodiments, such as for example as or in a concentrated formulation, the composition as described herein comprises at least about 1%, 1.5, 2, 2.5, 3, 3.5, 4, 4.5, 5, 0.5.5, 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29, 30, 35, 40, or more than 40% by weight one or more surfactants.

In various embodiments, such as for example as or in a concentrated formulation, the composition as described herein comprises from at least about 5% w/w to about 60% w/w one or more surfactants, such as from about 10% w/w to about 50% w/w one or more surfactants.

In various embodiments, the composition as described herein is a formulation comprising at least about 5 g·L⁻¹, 10, 20, 30, 40, 50, 60, 70, 80, 90, 100, 110, 120, 130, 140, 150, 160, 170, 180, 190, 200, 225, 250, 275, 300, 350, 400, 450, at least about 500, or more than 500 g·L⁻¹ of one or more surfactants.

In one embodiment, one or more of the one or more carbohydrates is a translocating carbohydrate that is preferentially targeted to and/or accumulates within the roots.

In certain embodiments, the translocating carbohydrate is targeted to and/or accumulating with the roots when applied via the foliage.

In one embodiment, the complex is a stable complex in which at least about 25% of the active agent present as a complex remains present in the complex during uptake by the plant with which the composition or complex is or has been contacted.

In one embodiment, the complex is a stable complex in which at least about 25% of the active agent present as a complex in the composition remains present in the complex during diffusion or transport into the phloem of the plant with which the composition or complex is or has been contacted.

In one embodiment, the complex is a stable complex in which at least about 25% of the active agent applied to the plant remains present as a complex for at least about 30 minutes after application.

In one embodiment, the complex is a stable complex in which at least about 25% of the active agent present in the plant, for example, present in the plant phloem, remains present as a complex for at least about 30 minutes. For example, the complex is a stable complex in which at least about 25% of the active agent present in the plant, such as in the plant phloem, remains present as a complex for at least about 30 minutes after uptake into the plant to which the composition or complex is or has been contacted.

In various embodiments, the mass ratio of surfactant to wounding agent present in the composition is at least about 1:1, for example, at least about 1.5:1, or about 2:1. For example, in particularly contemplated embodiments, the surfactant is an alkyl polyglucoside and is present at a mass ratio to wounding agent of at least 1:1. In another particularly contemplated embodiment, the wounding agent is a short or medium chain fatty acid, and the mass ratio of surfactant to short or medium chain fatty acid is at least 1:1.

In various embodiments, the composition is a concentrated composition suitable for dilution prior to application, and comprises from about 5% w/w to about 50% w/w carbohydrate;

from about 5% w/w to about 50% w/w aqueous solvent, such as water;

from about 5% w/w to about 30% w/w wounding agent;

from about 5% w/w to about 50% w/w surfactant; and

optionally from about 5% w/w to about 30% w/w humectant.

In various embodiments, the composition is a concentrated composition suitable for dilution prior to application, and comprises

from about 15% w/w to about 30% w/w carbohydrate;

from about 10% w/w to about 50% w/w aqueous solvent, such as water;

from about 15% w/w to about 30% w/w wounding agent;

from about 15% w/w to about 50% w/w surfactant; and

optionally from about 10% w/w to about 30% w/w humectant.

In various embodiments, the composition is a concentrated composition suitable for dilution prior to application, and comprises

from about 15% w/w to about 25% w/w carbohydrate;

from about 10% w/w to about 40% w/w aqueous solvent, such as water;

from about 15% w/w to about 25% w/w wounding agent;

from about 20% w/w to about 50% w/w surfactant; and optionally from about 10% w/w to about 25% w/w humectant.

In various embodiments, the composition is a concentrated composition suitable for dilution prior to application, and comprises

from about 15% w/w to about 25% w/w carbohydrate;

from about 10% w/w to about 25% w/w aqueous solvent, such as water;

from about 15% w/w to about 25% w/w wounding agent;

from about 15% w/w to about 40% w/w surfactant; and

optionally from about 10% w/w to about 25% w/w humectant.

In one embodiment, the composition comprises

from about 15% w/w to about 25% w/w sucrose;

from about 10% w/w to about 25% w/w aqueous solvent, such as water;

from about 15% w/w to about 25% w/w short or medium chain fatty acid;

from about 15% w/w to about 40% w/w akyl polyglucoside; and

optionally from about 10% w/w to about 25% w/w propylene glycol.

In one embodiment, the composition comprises

from about 15% w/w to about 20% w/w sucrose;

from about 10% w/w to about 20% w/w water;

from about 15% w/w to about 20% w/w short or medium chain fatty acid;

from about 15% w/w to about 40% w/w akyl polyglucoside; and

optionally from about 15% w/w to about 25% w/w propylene glycol.

In one embodiment, the composition comprises

about 20% w/w sucrose;

about 10% w/w water;

about 15% w/w short or medium chain fatty acid;

about 35% w/w akyl polyglucoside; and

optionally about 20% w/w propylene glycol.

In one embodiment, the composition comprises

about 20% w/w sucrose;

about 10% w/w water;

about 15% w/w caprylic (C8) and capric (C10) fatty acids;

about 35% w/w akyl polyglucoside; and

optionally about 20% w/w propylene glycol.

In various embodiments, the concentrated composition is diluted with one or more active agents selected from the group comprising one or more phytotoxins, one or more nutrients, and one or more organic molecules. For example, the concentrated composition is formulated for dilution with one or more active agents selected from the group comprising one or more phytotoxins, one or more nutrients, and one or more organic molecules.

In various embodiments, the concentrated composition is diluted with a suitable aqueous diluent, such as water, to a concentration suitable for application, such as a 10 fold dilution, a 100 fold dilution, or a 1000 fold dilution.

In various embodiments, the composition is or forms a microemulsion.

In other embodiments, the composition is a composition as herein described in the Examples.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7). These are only examples of what is specifically intended and all possible combinations of numerical values between the lowest value and the highest value enumerated are to be considered to be expressly stated in this application in a similar manner.

Those skilled in the art will appreciate the meaning of various terms of degree used herein. For example, as used herein in the context of referring to an amount (e.g., “about 9%”), the term “about” represents an amount close to and including the stated amount that still performs a desired function or achieves a desired result, e.g. “about 9%” can include 9% and amounts close to 9% that still perform a desired function or achieve a desired result. For example, the term “about” can refer to an amount that is within less than 10% of, within less than 5% of, within less than 1% of, within less than 0.1% of, or within less than 0.01% of the stated amount. It is also intended that where the term “about” is used, for example with reference to a figure, concentration, amount, integer or value, the exact figure, concentration, amount, integer or value is also specifically contemplated.

Other objects, aspects, features and advantages of the present invention will become apparent from the following description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

The invention is exemplified in the following non limiting embodiments and with reference to the accompanying FIGURES.

### BRIEF DESCRIPTION OF THE FIGURES

FIG. 1 is a photograph of a catnip plant 24 hours after foliar application of a composition as contemplated herein, as described in Example 3.

### DETAILED DESCRIPTION

The present invention recognises the advantage in horticulture and plant-based agriculture that can be achieved by enabling the translocation to the roots of active agents selected from the group comprising one or more phytotoxins, one or more nutrients, and one or more organic molecules, that have been applied to plant foliage. Accordingly, the invention relates to compositions comprising one or more carbohydrates that can act as translocators and one or more active agents selected from the group comprising one or more phytotoxins, one or more nutrients, and one or more organic molecules, to be translocated after uptake via the plant foliage.

As used herein, an “active agent” is an agent that mediates some biological effect on a target organism, environment, or system.

As used in this specification, the words “comprise”, “comprises”, “comprising”, and similar words, are not to be interpreted in an exclusive or exhaustive sense. In other words, they are intended to mean “including, but not limited to”. When interpreting each statement in this specification that includes the term “comprising”, features other than that or those prefaced by the term may also be present.

The term “control” or “controlling” as used herein generally comprehends preventing, reducing, or eradicating a target organism or population, or inhibiting the rate and extent of growth of such population, such as reducing the number or viability of undesired plants around a desired plant or its surroundings, wherein such prevention or reduction in the undesired target population or in a treated locus/locii is statistically significant with respect to untreated locii or population(s). Curative treatment is also contemplated. In particularly contemplated embodiments, such control is achieved by increased mortality amongst the undesired target population.

As used herein, a “phytotoxin” or a “phytotoxic agent” is an agent which parasitizes, incapacitates, renders infertile, impedes or inhibits the growth of, impedes or inhibits the spread or distribution of, and/or kills the target plant or plant population.

The phrases “phytotoxic activity” and “phytotoxic efficacy” are used interchangeably herein and refer to the ability of certain active agents, for example herbicides such as botrydial, to antagonise one or more plants, such as one or more weeds or undesired plants.

In various embodiments, said phytotoxic efficacy is the ability to parasitise or support parasitism of, incapacitate, render infertile, impede or inhibit the growth of, or kill one or more plants, preferably within 14 days of contact with the plant, more preferably within 7 days, more preferably still the ability to kill one or more plants, or the ability to kill one or more plants within 7 days of contact.

As used herein a “phytotoxic composition” is a composition which comprises or includes at least one active agent that is an antagonist of one or more (typically undesired) plants. Antagonism may take a number of forms. In various forms, the active agent parasitizes, incapacitates, renders infertile, impedes or inhibits the growth of, impedes or inhibits the spread or distribution of, and/or kills the target plant or plant population. Such a composition is herein considered to have phytotoxic efficacy. Particularly contemplated are phytotoxic compositions capable of killing one or more plants, and particularly compositions capable of killing one or more plants within about 7 days.

Methods and assays to determine phytotoxic efficacy are well known in the art, and include assays of the ability of an active agent to kill or otherwise antagonise a target plant or plant population. Phytotoxic compositions particularly contemplated herein are those capable of killing or otherwise antagonising a statistically significant proportion of the target plant or plant population when compared to control compositions, such as control compositions lacking a or the active agent.

The term “plant” as used herein encompasses not only whole plants, but extends to plant parts, cuttings as well as plant products including roots, leaves, flowers, seeds, stems, callus tissue, nuts and fruit, bulbs, tubers, corms, grains, cuttings, root stock, or scions, and includes any plant material whether pre-planting, during growth, and at or post harvest. Plants that may benefit from the application as described herein cover a broad range of agricultural and horticultural crops.

The compositions as described herein are especially suitable for application in organic production systems.

The term “surroundings” when used in reference to a plant subject to the methods and compositions as described herein includes soil, water, leaf litter, and/or growth media adjacent to or around the plant or the roots, tubers or the like thereof, adjacent plants, cuttings of said plant, supports, water to be administered to the plant, and coatings including seed coatings. It further includes storage, packaging or processing materials such as protective coatings, boxes and wrappers, and planting, maintenance or harvesting equipment.

The compositions described herein comprise one or more carbohydrates and one or more active agents selected from the group comprising one or more phytotoxins, one or more nutrients, and one or more organic molecules, optionally one or more surfactants, and optionally one or more wounding agents.

In various embodiments, the one or more carbohydrates present in the composition are one or more disaccharides, such as sucrose. As shown herein in the Examples, experiments have shown that simple sugars such as sucrose are rapidly translocated and are able to aid the systemic translocation of other compounds, including translocation into the root system. For example, the movement of foliar applied organic dye to the roots was much quicker and more extensive when applied in a composition comprising sucrose than that observed in control experiments with compositions lacking carbohydrate.

The one or more carbohydrates are present in the composition in an amount or at a concentration effective to increase uptake and/or translocation of the one or more active agents from the site of application.

In one embodiment, the carbohydrate is present in an amount or at a concentration on application that is effective to increase translocation of the one or more active agents to the roots of the plant. For example, the carbohydrate is present in an amount or at a concentration at application effective to increase the amount or concentration of the one or more active agents in the roots beyond the amount or concentration achieved in the absence of the carbohydrate.

In one embodiment, the carbohydrate is present in an amount or at a concentration on application that is effective to increase translocation of the one or more active agents substantially throughout the plant. For example, the carbohydrate is present in an amount or at a concentration at application effective to increase systemic distribution of the one or more active agents beyond the systemic distribution achieved in the absence of the carbohydrate.

Methods to assess both the systemic distribution, and the amount or concentration of a compound or agent at a given locus within the plant, such as for example the roots, are well known to those of skill in the art, and include the methods exemplified herein in the Examples.

While disaccharide carbohydrates are particularly contemplated in certain embodiments herein, monosaccharides and polysaccharides are also contemplated for use in the compositions described herein.

In principal, any agriculturally acceptable active agents selected from the group comprising one or more phytotoxins, one or more nutrients, and one or more organic molecules are amenable to use in the compositions described herein. However, said active agents of biological origin, that is, biologically derived active agents, such as biologically derived phytotoxins, are particularly contemplated.

Examples of specifically contemplated biologically derived phytotoxic agents include phytotoxic microorganisms, such as Botrytis spp., Rhizopus spp., Sclerotinia minor, Mucor spp., Erwinia carotovora subsp. caratovora, and Pseudomonas spp., such as Pseudomonas syringae, one or more phytotoxic metabolites of a phytotoxic microorganism, one or more extracts, including for example a culture media or media extract, from a phytotoxic microorganism, such as botrydial, one or more enzymes, and one or more inducers of acquired resistance, such as systemic acquired resistance.

In various embodiments, the one or more phytotoxins is one or more herbicides. For example, the herbicide is a synthetic herbicide. Many synthetic herbicides are known to those skilled in the art, and are amenable to use in the compositions described herein.

Representative herbicides for use in phytotoxic compositions herein include herbicides of the following classes.
Acetolactate synthase (ALS) inhibitors, which have a proposed mode of action comprising the inhibition of a step of the branched chain amino acids biosynthesis in plants. Examples include triazolopyrimidine herbicides; sulfonylamino-carbonyl-triazolinone herbicides; and pyrimidinyl(thio) benzoate herbicides.

Triazolopyrimidine herbicides include e.g. cloransulam, diclosulam, florasulam, flumetsulam, metosulam, penoxsulam and pyroxsulam, and the salts and esters thereof such as cloransulam-methyl.

Sulfonylamino-carbonyl-triazolinone herbicides include e.g. flucarbazone, propoxycarbazone, thiencarbazone and triafamone, and the salts and esters thereof such as flucarbazone-sodium, propoxycarbazone-sodium and thiencarbazone-methyl.

Pyrimidinyl(thio) benzoate herbicides include e.g. bispyribac, pyribenzoxim, pyriftalid, pyrimisulfan, pyrithiobac, pyriminobac, the salts and esters thereof such as bispyribac-sodium, pyrithiobac-sodium and pyriminobac-methyl, as well as 4-[[[2-[(4,6-dimethoxy-2-pyrimidinyl)oxy]phenyl]methyl]amino]-benzoic acid-1-methylethyl ester (CAS 420138-41-6), 4-[[[2-[(4,6-dimethoxy-2-pyrimidinyl)oxy]phenyl]methyl]amino]-benzoic acid propyl ester (CAS 420138-40-5) and N-(4-bromophenyl)-2-[(4,6-dimethoxy-2-pyrimidinyl)oxy]benzenemethanamine (CAS 420138-01-8).
Protoporphyrinogen-IX-oxidase (PPO) inhibitors, which have a reported mode of action comprising the inhibition of a step of the chlorophyll biosynthesis in plants. Examples include pyrimidinedione herbicides; triazolinone herbicides; diphenyl ether herbicides; and N-phenyl phthalimide herbicides.

Pyrimidinedione herbicides include e.g. benzfendizone, butafenacil, saflufenacil, tiafenacil, ethyl [3-[2-chloro-4-fluoro-5-(1-methyl-6-trifluoromethyl-2,4-dioxo-1,2,3,4-tet-rahydropyrimidin-3-yl)phenoxy]-2-pyridyloxy]acetate (CAS 353292-31-6), 1-methyl-6-trifluoromethyl-3-(2,2,7-trifluoro-3-oxo-4-prop-2-yny-3,4-dihy-dro-2H-benzo[1,4]oxazin-6-yl)-1H-pyrimidine-2,4-dione and 3-[7-chloro-5-fluoro-2-(trifluoromethyl)-1H-benzimidazol-4-yl]-1-methyl-6-(trifluoromethyl)-1H-pyrimidine-2,4-dione (CAS 212754-02-4) and their salts, in particular the lithium salts, sodium salts, potassium salts, ammonium salts or substituted ammonium salts as defined above, in particular mono-, di- and tri-C₁-C₈-alkylammonium salts such as methylammonium, dimethylammonium and isopropylammonium.

Triazolinone herbicides include e.g. azafenidin, amicarbazone, bencarbazone, carfentrazone, ipfencarbazone and sulfentrazone and their salts, in particular the sodium salts, potassium salts, ammonium salts or substituted ammonium salts as defined above, in particular mono-, di- and tri-C₁-C₈-alkylammonium salts such as methylammonium, dimethylammonium and isopropylammonium, and their esters, in particular the C₁-C₈-alkyl esters, such as methyl ester, ethyl ester or isopropyl ester. A suitable example of such esters is carfentrazone-ethyl.

Diphenyl ether herbicides include e.g. ethoxyfen, acifluorfen, aclonifen, bifenox, chlomethoxyfen, chlornitrofen, etnipromid, fluorodifen, fluoroglycofen, fluoronitrofen, fomesafen, fucaomi, furyloxyfen, halosafen, lactofen, nitrofen, nitrofluorfen and oxyfluorfen and their salts, in particular the sodium salts, potassium salts, ammonium salts or substituted ammonium salts as defined above, in particular mono-, di- and tri-C₁-C₈-alkylammonium salts such as methylammonium, dimethylammonium and isopropylammosdnium, and their esters, in particular the C₁-C₈-alkyl esters, such as methyl ester, ethyl ester or isopropyl ester. Suitable examples of such salts are acifluorfen-sodium and fomesafen-sodium. Suitable examples of such esters are ethoxyfen-ethyl, acifluorfen-methyl and fluoroglycofen-ethyl.

N-Phenyl phthalimide herbicides include e.g. cinidon, flumioxazin, flumiclorac, flumipropyn and 2-(2,2,7-trifluoro-3-oxo-4-prop-2-ynyl-3,4-dihydro-2H-benzo[1,4]oxazin-6-yl)-4,5,6,7-tetrahydro-isoindole-1,3-dione. Also included are the salts of cinidon and flumiclorac, in particular their sodium salts, potassium salts, ammonium salts or substituted ammonium salts as defined above, in particular mono-, di and tri-C₁-C₈-alkylammonium salts such as isopropylammonium salts, and the esters of cinidon and flumiclorac, in particular their C₁-C₈-alkyl esters, such as methylesters, ethylesters, isopropyl esters. Suitable examples of such esters are cinidon-ethyl and flumiclorac-pentyl.
Synthetic auxins, compounds which act like the phytohormones auxins such as indole-3-acetic acid. Examples include benzoic acid herbicides; quinolinecarboxylic acid herbicides; pyridine carboxylic acid herbicides; and phenoxycarboxylic acid herbicides.

Benzoic acid herbicides include e.g. dicamba, tricamba, chloramben and 2,3,6-TBA (2,3,6-trichlorobenzoic acid), and the salts and esters thereof.

Quinolinecarboxylic acid herbicides include e.g. quinclorac and quinmerac, and their salts and esters, such as quinclorac-dimethylammonium.

Pyridinecarboxylic acid herbicides include e.g. aminopyralid, clopyralid, halauxifen, picloram, triclopyr and fluroxypyr, and their salts and their esters, such as aminopyralid-dimethylammonium, aminopyralid-tris(2-hydroxypropyl)ammonium, fluroxypyr-butometyl and fluroxypyr-meptyl.

Phenoxycarboxylic acid herbicides include, e.g. phenoxyacetic acid herbicides such as 2,4-D, 3,4-DA, MCPA, MCPA-thioethyl, 2,4,5-T, phenoxypropionic acid herbicides such as 2,4-DP (dichlorprop), 2,4-DP-P, 4-CPP, 3,4-DP, fenoprop, CMPP (mecoprop), CM PP-P (mecoprop-P), and phenoxybutyric acid herbicides such as 4-CPB, 2,4-DB, 3,4-DB, 2,4,5-TB, MCPB, and their salts and their esters.
Microtubule assembly inhibitors, which have a reported mode of action comprising the inhibition of the microtubule assembly in plants. Examples include dinitroaniline herbicides, such as benfluralin, butralin, dinitramine, ethalfluralin, fluchloralin, oryzalin, pendimethalin, prodiamine and trifluralin; phosphoroamidate herbicides, such as amiprophos, amiprophos-methyl and butamiphos; pyridine herbicides, such as dithiopyr and thiazopyr; benzamide herbicides, such as propyzamide and tebutam; and benzoic acid herbicides, such as chlorthal and chlorthal-dimethyl.
acetyl-CoA carboxylase (ACC) inhibitors, which have a reported mode of action comprising the inhibition of the lipid biosynthesis in plants. Examples include aryloxyphenoxy-propionate herbicides; cyclohexanedione herbicides; phenylpyrazoline herbicides; and certain unclassified herbicides.

Aryloxyphenoxy-propionate herbicides include e.g. chlorazifop, clodinafop, clofop, cyhalofop, diclofop, fenoxaprop, fenthiaprop, fluazifop, haloxyfop, isoxapyrifop, kuicaoxi, metamifop, propaquizafop, quizalofop, trifop and their enantiomers, salts and esters, such as fenoxaprop-P, fluazifop-P, haloxyfop-P, quizalofop-P, haloxyfop-sodium, chlorazifop-propargyl, clodinafop-propargyl, clofop-isobutyl, cyhalofop-butyl, diclofop-methyl, fenoxaprop-ethyl, fenoxaprop-P-ethyl, fenthiaprop-ethyl, fluazifop-methyl, fluazifop-butyl, fluazifop-P-butyl, haloxyfop-etotyl, haloxyfop-methyl, haloxyfop-P-etotyl, haloxyfop-P-methyl, quizalofop-ethyl, quizalofop-tefuryl, quizalofop-P-ethyl and quizalofop-P-tefuryl.

Cyclohexanedione herbicides include e.g. alloxydim, butroxydim, clethodim, cloproxydim, cycloxydim, profoxydim, sethoxydim, tepraloxydim, tralkoxydim and their salts, such as alloxydim-sodium.

Phenylpyrazoline herbicides include in particular pinoxaden.

Unclassified herbicides suitable for use as ACC inhibitors include e.g. 4-(4′-chloro-4-cyclopropyl-2′-fluoro[1,1′-biphenyl]-3-yl)-5-hydroxy-2,2,6-6-tetramethyl-2H-pyran-3(6H)-one (CAS 1312337-72-6); 4-(2′,4′-dichloro-4-cyclopropyl[1,1′-biphenyl]-3-yl)-5-hydroxy-2,2,6,6-te-tramethyl-2H-pyran-3(6H)-one (CAS 1312337-45-3); 4-(4′-chloro-4-ethyl-2′-fluoro[1,1′-biphenyl]-3-yl)-5-hydroxy-2,2,6,6-tet-ramethyl-2H-pyran-3(6H)-one (CAS 1033757-93-5); 4-(2′,4′-cichloro-4-ethyl[1,1′-biphenyl]-3-yl)-2,2,6,6-tetramethyl-2H-pyr-an-3,5(4H,6H)-dione (CAS 1312340-84-3); 5-(acetyloxy)-4-(4′-chloro-4-cyclopropyl-2′-fluoro[1,1′-biphenyl]-3-yl)-3-6-dihydro-2,2,6,6-tetramethyl-2H-pyran-3-one (CAS 1312337-48-6); 5-(acetyloxy)-4-(2′,4′-dichloro-4-cyclopropyl-[1,1′-biphenyl]-3-yl)-3,6-d-ihydro-2,2,6,6-tetramethyl-2H-pyran-3-one; 5-(acetyloxy)-4-(4′-chloro-4-ethyl-2′-fluoro[1,1′-biphenyl]-3-yl)-3,6-dih-ydro-2,2,6,6-tetramethyl-2H-pyran-3-one (CAS 1312340-82-1); 5-(acetyloxy)-4-(2′,4′-dichloro-4-ethyl[1,1′-biphenyl]-3-yl)-3,6-dihydro-2,2,6,6-tetramethyl-2H-pyran-3-one (CAS 1033760-55-2); 4-(4′-chloro-4-cyclopropyl-2′-fluoro[1,1′-biphenyl]-3-yl)-5,6-dihydro-2,2-6,6-tetramethyl-5-oxo-2H-pyran-3-yl carbonic acid methyl ester (CAS 1312337-51-1); 4-(2′,4′-Dichloro-4-cyclopropyl-[1,1′-biphenyl]-3-yl)-5,6-dihydro-2,2,6,6-tetramethyl-5-oxo-2H-pyran-3-yl carbonic acid methyl ester; 4-(4′-chloro-4-ethyl-2′-fluoro[1,1′-biphenyl]-3-yl)-5,6-dihydro-2,2,6,6-t-etramethyl-5-oxo-2H-pyran-3-yl carbonic acid methyl ester (CAS 1312340-83-2); and 4-(2′,4′-dichloro-4-ethyl[1,1′-biphenyl]-3-yl)-5,6-dihydro-2,2,6,6-tetram-ethyl-5-oxo-2H-pyran-3-yl carbonic acid methyl ester (CAS 1033760-58-5), variously as described in WO 2010/136431, WO 2011/073615 and WO 2011/073616.
Photosystem II inhibitors, which have a reported mode of action comprising the inhibition of the electron transfer in photosystem II of the photosynthetic pathway in plants. Examples include arylurea herbicides; triazin(di)one herbicides; triazine herbicides; pyridazinone herbicides; phenylcarbamate herbicides; nitrile herbicides; benzothiadiazinone herbicides; and uracil herbicides.

Arylurea herbicides herbicides include e.g. chlorbromuron, chlorotoluron, chloroxuron, dimefuron, diuron, ethidimuron, fenuron, fluometuron, isoproturon, isouron, linuron, methabenzthiazuron, metobenzuron, metobromuron, metoxuron, monolinuron, neburon, siduron, tetrafluron, tebuthiuron, thiadiazuron and their salts and esters.

Triazin(di)one herbicides (i.e. triazinone and triazindione herbicides) include e.g. ametridione, amibuzin, ethiozin, hexazinone, isomethiozin, metamitron, metribuzin, trifludimoxazin and their salts and esters.

Triazine herbicides include e.g. ametryn, atrazine, aziprotryne, chlorazine, cyanatryn, cyanazine, cyprazine, desmetryn, dimethametryn, eglinazine, ipazine, mesoprazine, methoprotryne, prometryn, procyazine, proglinazine, prometon, propazine, sebuthylazine, simazine, simetryn, terbumeton, terbuthylazine, terbutryn, trietazine and their salts and esters, such as eglinazine-ethyl and proglinazine-ethyl.

Pyridazinone herbicides include e.g. brompyrazon, chloridazon, dimidazon, metflurazon, norflurazon, oxapyrazon, pydanon and their salts and esters.

Phenylcarbamate herbicides include e.g. desmedipham, karbutilate, phenisopham, phenmedipham and their salts and esters, such as phenmedipham-ethyl.

Nitrile herbicides include e.g. bromobonil, bromofenoxim, bromoxynil, chloroxynil, dichlobenil, iodobonil and ioxynil and their salts and esters, in particular in case of bromoxynil, chloroxynil and ioxynil.

Benzothiadiazinone herbicides include bentazone and its salts, in particular its alkalimetal salts, such as bentazone-sodium.

Uracil herbicides include e.g. bromacil, flupropacil, isocil, lenacil, terbacil and the salts of bromacil, in particular its alkalimetal salts, such as bromacil-lithium and bromacil-sodium.
Inhibitors of pigment synthesis, which have a reported mode of action comprising the inhibition of carotenoid biosynthesis in plants. Examples include phytoene desaturase (PDS) inhibitors; 4-hydroxyphenylpyruvate dioxygenase (HPPD) inhibitors; inhibitors of unknown target; and 1-deoxyxylulose-5-phosphate (DOXP) synthase inhibitors.

PDS inhibitors include e.g. pyridazinone herbicides, such as norflurazon, pyridinecarboxamide herbicides, such as flufenican, diflufenican and picolinafen, as well as herbicides not belonging to a common group, such as beflubutamid, fluridone, flurochloridone, flurtamone and 4-(3-trifluoromethylphenoxy)-2-(4-trifluoromethylphenyl)pyrimidine (CAS 180608-33-7).

HPPD inhibitors include e.g. cyclopropylisoxazole herbicides, such as isoxachlortole and isoxaflutole, benzoylcyclohexanedione herbicides, such as fenquinotrione, ketospiradox, mesotrione, sulcotrione, tefuryltrione and tembotrione, benzoylpyrazole herbicides, such as benzofenap, pyrasulfotole, pyrazolynate, pyrazoxyfen, tolpyralate and topramezone, as well as unclassified herbicides, such as benzobicyclon and bicyclopyrone.

Isoxaflutole is a well known herbicide and commercially available, e.g. under the trade name BALANCE® and MERLIN®. Mesotrione is a well known herbicide and commercially available, e.g. under the trade name CALLISTO®. Sulcotrione is a well known herbicide and commercially available, e.g. under the trade name MIKADO®. Tropramzone is a well known herbicide and commercially available, e.g. under the trade names IMPACT® and CLIO®.

Suitable inhibitors of unknown target include e.g. amitrole, fluometuron and aclonifen.

Suitable DOXP synthase inhibitors inhibitors include e.g. clomazone.
Very long chain fatty acid (VLCFA) synthesis inhibitors, which have a reported mode of action comprising the inhibition of the VLCFA synthesis and/or the inhibition of cell division in plants. Examples include chloroacetamide herbicides, such as acetochlor, alachlor, butachlor, dimethachlor, dimethenamid, metazachlor, metolachlor, pethoxamid, pretilachlor, propachlor, propisochlor, thenylchlor and their enantiomers, salts and esters, such as dimethenamid-P and S-metolachlor; oxyacetamide herbicides, such as flufenacet and mefenacet; acetamide herbicides, such as as diphenamid, napropamide, naproanilide and their enantiomers, such as napropamide-M; tetrazolinone herbicides, such as fentrazamide; as well as certain unclassified herbicides, such as anilofos, cafenstrole, fenoxasulfone, ipfencarbazone, pyroxasulfone, piperophos and isoxazoline compounds.

In various embodiments, the herbicide is selected from the group comprising EPSP synthase inhibitors, including for example glycines; glutamine synthesis inhibitors, including for example phosphinic acid; DOXP synthase inhibitors, including for example isoxazolidinone; HPPD inhibitors, including for example pyrazole, and triketone; and Photosystem I inhibitors, including for example bipyridyliums

Representative examples of herbicides particularly contemplated for use in the phytotoxic compositions described herein include glyphosate, glufosinate, diclosulam, cloransulam, flumetsulam, thiencarbazone, flumioxazin, butafenacil, carfentrazone, sulfentrazone, acifluorfen, fomesafen, lactofen, oxyfluorfen, quinclorac, fluroxypyr, 2,4-D, pendimethalin, fenoxaprop, haloxyfop, clethodim, sethoxydim, profoxydim, atrazine, metribuzin, bentazone, benzobicyclon, benzofenap, bicyclopyrone, clomazone, isoxaflutole, mesotrione, pyrasulfotole, pyrazolynate, pyrazoxyfen, sulcotrione, tefuryltrione, tembotrione, topramezone, acetochlor, metolachlor, metazachlor, and flufenacet, and/or an agriculturally acceptable enantiomer, salt or ester thereof.

In specifically contemplated examples of phytotoxic compositions according to this disclosure, the synthetic herbicide is selected from the group comprising glyphosate, glufosinate, sulfonylurea, and imidazolinone herbicides.

In one embodiment, the herbicide is selected from the group of glufosinate, its agriculturally acceptable enantiomers, such as in particular glufosinate-P, its agriculturally acceptable salts, such as in particular glufosinate-ammonium, glufosinate-sodium, glufosinate-P-ammonium and glufosinate-P-sodium, or a mixture of any of these compounds.

Reference herein to a particular agent or compound is meant to include the respective salts, isomers/enantiomers and esters of the agent or compound, unless the context indicates otherwise. Typically, for example in reference to one or more herbicides recited herein, suitable salts include salts of alkaline or earth alkaline metals or ammonium or organoammonium salts, for instance, sodium, potassium, ammonium, isopropyl ammonium, etc. Suitable isomers are for example stereo isomers such as the enantiomers. Suitable esters are e.g. C₁-C₈-(branched or non-branched) alkyl esters, such as methyl esters, ethyl esters and isopropyl esters.

In various embodiments, the one or more active agents is one or more phytobeneficial agents, such as one or more nutrients. In certain embodiments, the one or more nutrients is selected from the group comprising elemental Boron, Calcium, Chlorine, Chromium, Cobalt, Copper, Fluorine, Iodine, Iron, Magnesium, Manganese, Molybdenum, Phosphorous, Potassium, Selenium, Silicon, Sodium, Zinc, or salts or derivatives thereof.

In one embodiment, the one or more nutrients comprises at least one of elemental sulphur, elemental boron, Boron carbide, Boron nitride, Aluminum oxide, Aluminum dodecaboride, aluminum hydroxide, bauxite, calcitic limestone, Calcium oxalate, Chromium oxide, Cobalt oxide, Cobalt sulphide, Cobalt molybdate, Cobalt carbonate, Copper oxalate, Copper oxide, Copper Sulphide, Copper hydroxide, Cupric sulphide, Copper phosphate, Copper molybdate, Fluorine oxide, Fluorine molybdate, Iron oxide, Iron sulphide, Magnesium oxide, Magnesium hydroxide, Magnesium phosphate tribasic, Magnesium molybdate, Magnesium carbonate, Manganese oxide, Manganese molybdate, Molybdenum acetate, Molybdenum disulphide, Selenium sulphide, Silicon nitride, Zinc sulphide, Zinc oxide, Zinc carbonate, Zinc phosphate, Zinc molybdate, basic slag, elemental chromium, chromium phosphate, iron sucrate, cobalt phosphide, cobalt cyanide, elemental nickel, nickel oxide, nickel oxyhydroxide, nickel carbonate, nickel chromate, nickel hydroxide, millerite, nickel selenide, nickel phosphide, elemental copper, insoluble copper cyanide, chalcocite, copper selenide, copper phosphide, covellite, copper arsenate, elemental silver, elemental zinc, zinc chromate, zinc pyrophosphate, tin hydroxide, tin oxide and tin sulfide, their salts, derivatives and combinations thereof.

In one embodiment, the nutrient is a vitamin, such as, but not limited to Vitamin A, Vitamin B, Vitamin C, Vitamin D, Vitamin E and Vitamin K. However, those skilled in the art will appreciate that it is possible to use other vitamins without departing from the scope of this disclosure.

In another embodiment, the one or more phytobeneficial agents is an algae, such as a microalgae, a freshwater algae, a saltwater algae, or derivatives or mixtures thereof. For example, the algae is in certain embodiments selected from the group comprising green algae, red algae, golden algae, brown algae, golden-brown algae, blue algae or blue-green algae, Asian tuen shaped flat algaes or sea weeds or their derivatives, species and mixtures thereof.

In another embodiment, the one or more phytobeneficial agents is a biostimulant, such as an enzyme, humic acid, fulvic acid, a bacteriospore, or a microbe such as fungi, yeast or viruses.

In another embodiment, the one or more phytobeneficial agents is a fertilizer, such as a fertilizer selected from the group comprising urea, sulphur based fertilizers, phosphate fertilizers such as MAP, DAP, potash fertilizers, potassium fertilizers, nitrogen fertilizers, NPK fertilizers, ferrous sulphate, magnesium sulphate, manganese sulphate, copper sulphate, sodium molybdate, zinc sulphate, boric acid, or derivatives, salts, complexes and mixtures thereof.

Wounding agents are present in the compositions described herein to facilitate uptake of the translocating carbohydrate and the one or more active agents into the plant. A wide variety of wounding agents are known, including lipolytic enzymes, super wetting agents, and fatty acids, particularly short chain and medium chain fatty acids. Abrasives are also used as wounding agents, along with applicative methods that include or induce some degree of physical trauma to the plant. Of these, short and medium chain fatty acids are particularly contemplated.

Without wishing to be bound by any theory, the applicant believes that to assist with the good coverage of plant foliage and penetration of the active agent with the translocation carbohydrate, the inclusion in the composition of a surfactant is usually desirable. This facilitates the reduction of surface tension and good spreading and wetting of the (usually aqueous) carbohydrate composition over the foliage, which is generally hydrophobic.

While in theory each of the three main surfactant types could be used (i.e. anionic, non-ionic and cationic), the broad compatibility of non-ionic surfactants renders this class of surfactants particularly suited to application in the compositions described herein.

The most commonly used non-ionic surfactants are ethoxylated compounds, including alcohol ethoxylates, alcohol ethoxysulfates, and poloxamers. However, ethoxylate preparations sometimes containing residues of dioxin.

Alkylpolyglucosides are a class of non-ionic surfactants that are not ethoxylated, but are combinations of fatty compounds (the lipophilic component) together with poly-glucose (the hydrophilic component). Alkylpolyglucosides are particularly contemplated for use in the compositions described herein, not least as they are generally non-phytotoxic, are derived from plant materials and are renewable, are bio-degradable, and are very salt and pH tolerant.

In certain embodiments, the composition comprises an agriculturally acceptable carrier. In one embodiment, the carrier is an agriculturally acceptable carrier selected from the group consisting of a filler stimulant, an anti-caking agent, a wetting agent, an emulsifier, and an antioxidant. For example, the composition comprises two or more of a filler stimulant, an anti-caking agent, a wetting agent, an emulsifier, and an antioxidant. To be suitable for application to a plant or its surroundings, said at least one carrier is an agriculturally acceptable carrier, for example a carrier selected from the group consisting of a filler stimulant, an anti-caking agent, a wetting agent, an emulsifier, and an antioxidant, more preferably said composition comprises at least one of each of a filler stimulant, an anti-caking agent, a wetting agent, an emulsifier, and an antioxidant. In certain embodiments, said anti-caking agent is selected from talc, silicon dioxide, calcium silicate, or kaelin clay, said wetting agent is skimmed milk powder, said emulsifier is a soy-based emulsifier such as lecithin or a vegetable-based emulsifier such as monodiglyceride, and said antioxidant is sodium glutamate or citric acid. However, other examples well known in the art may be substituted, provided the ability of the composition to support efficacy, is maintained.

In various embodiments, a desiccation protection agent, such as Deep Fried™, Fortune™, or Fortune Plus™, is admixed to a final concentration of about 1 ml/L prior to application.

In one embodiment, compositions as described herein are applied directly to the plant or its surroundings. For example, a composition as described herein is admixed with a solvent, for example water, and applied as described herein.

In one embodiment, the present invention provides a method for controlling one or more plants, the method comprising applying to a plant or its surroundings a composition as described herein.

In various embodiments, the composition is admixed with water to a final concentration of active agent of about 0.5 gm/L to about 10 gm/L prior to application, for example to a final concentration of about 1 gm/L.

Convenient and effective rates of application can be achieved by formulating the composition to deliver an effective amount of the active agent, and applying said composition at a rate of about 1 L per hectare. As discussed herein, such an application rate can be conveniently achieved by dissolution of the composition in a larger volume of agriculturally acceptable solvent, for example, water.

In various embodiments, the composition is admixed with water prior to application. In one embodiment, the composition is admixed with water and applied in at least about 100 L water/Ha, in at least about 150 L/Ha, in at least about 200 L/Ha, in at least about 250 I/Ha, in at least about 300 L/Ha, in at least about 350 L Ha, in at least about 400 L/Ha, in at least about 450 L/Ha, or in at least about 500 L/Ha.

Generally, said application is by spraying.

The invention is applicable to any plant or its surroundings. Exemplary plants are in certain embodiments monocotyledonous or dicotyledonous plants such as alfalfa, barley, canola, corn, cotton, flax, kapok, peanut, potato, oat, rice, rye, sorghum, soybean, sugarbeet, sugarcane, sunflower, tobacco, tomato, wheat, turf grass, pasture grass, berry, fruit, legume, vegetable, ornamental plants, shrubs, cactuses, succulents, and trees. In further illustrative embodiments, the plant may be any plant, including plants selected from the order Solanales, including plants from the following families: Convolvulaceae, Hydroleaceae, Montiniaceae, Solanaceae, and Sphenocleaceae, and plants from the order Asparagales, including plants from the following families: Amaryllidaceae, Asparagaceae, Asteliaceae, Blandfordiaceae, Boryaceae, Doryanthaceae, Hypoxidaceae, Iridaceae, Ixioliriaceae, Lanariaceae, Orchidaceae, Tecophilaeaceae, Xanthorrhoeaceae, and Xeronemataceae.

The applicant contemplates that certain embodiments of the compositions disclosed herein will find particular utility as control compositions for topical application during weed management of field crops, grasses, fruits and vegetables, lawns, trees, and/or ornamental plants. In other embodiments, the compositions disclosed herein will find particular utility as phytobeneficial compositions for topical application to increase crop production, plant vigour, fruit or flower setting, and the like during management of field crops, grasses, fruits and vegetables, lawns, trees, and/or ornamental plants

The compositions disclosed herein may be formulated as a spray, dust, powder, or other aqueous, atomized or aerosol for application, for example for killing a target organism, or controlling a target population.

The compositions disclosed herein may be used prophylactically. Phytotoxic compositions contemplated herein will generally be administered to an environment once target plants have been identified in the particular environment to be treated.

The compositions may comprise a single active agent, or may contain various combinations of active agents, including various combinations of the phytotoxins disclosed herein.

Regardless of the method of application, the amount of the active agent applied is at an effective amount, which will vary depending on such factors as, for example, the specific target organisms to be controlled, the particular plants to which the compositions are to be applied, the particular benefit to be conferred, the specific environment, location, plant, crop, or agricultural site to be treated, the environmental conditions, and the method, rate, concentration, stability, and quantity of application of the active agent comprising composition. The formulations may also vary with respect to climatic conditions, environmental considerations, and/or frequency of application and/or severity of target growth/infestation.

The compositions described may be made by formulating the one or more active agents selected from the group comprising one or more phytotoxins, one or more nutrients, and one or more organic molecules, the one or more carbohydrates, the one or more wounding agents, optionally together with one or more surfactants, together with one or more desired agriculturally-acceptable carrier. The compositions may be formulated prior to administration in an appropriate means such as lyophilized, freeze-dried, desiccated, or in an aqueous carrier, medium or suitable diluent, such as saline or other buffer. The formulated compositions may be in the form of a dust or granular material, or a suspension in oil (vegetable or mineral), or water or oil/water emulsions, or as a wettable powder, or in combination with any other carrier material suitable for agricultural application. Suitable agricultural carriers can be solid or liquid and are well known in the art.

The term “agriculturally-acceptable carrier” covers all adjuvants, inert components, dispersants, surfactants, tackifiers, binders, etc. that are ordinarily used in agricultural formulation technology; these are well known to those skilled in agricultural formulation. The formulations may be mixed with one or more solid or liquid adjuvants and prepared by various means, e.g., by homogeneously mixing, blending and/or grinding the composition with suitable adjuvants using conventional formulation techniques.

The compositions may include one or more microorganisms, such as one or more fungal strains, one or more bacterial species, or both. In certain embodiments, one or more phytotoxins present in a composition as contemplated herein is a microorganism, or an extract or metabolite therefrom. Exemplary species include those such as Botrytis spp., Rhizopus spp., Sclerotinia minor, Mucor spp., Erwinia carotovora subsp. caratovora, or Pseudomonas spp., such as Pseudomonas syringae.

In one exemplary embodiment, the composition comprises an oil flowable suspension, such as an oil flowable suspension of one or more phytotoxins as described herein.

In another important exemplary embodiment, the composition comprises a water dispersible granule. In one embodiment, the granule comprises one or more phytotoxin as described herein together with one or more translocating carbohydrates.

In a third important exemplary embodiment, the composition comprises a wettable powder, dust, pellet, or colloidal concentrate. Such dry forms of the compositions may be formulated to dissolve immediately upon wetting, or alternatively, dissolve in a controlled-release, sustained-release, or other time-dependent manner.

In a fourth important exemplary embodiment, the composition comprises an aqueous solution or suspension of the one or more active agents, such as one or more of the phytotoxins as described herein. Such aqueous solutions or suspensions are in certain embodiments provided as a concentrated stock composition which is diluted prior to application, or alternatively, as a diluted composition ready-to-apply.

In a further exemplary embodiment, the composition comprises a microemulsion. When the compositions comprise intact cells, such as live microorganism producing a phytotoxic metabolite or live cells conferring a benefit to the plant with which they are contacted, such cells may be formulated in a variety of ways. They may be employed as wettable powders, granules or dusts, by mixing with various inert materials, such as inorganic minerals (phyllosilicates, carbonates, sulfates, phosphates, and the like) or botanical materials (powdered corncobs, rice hulls, walnut shells, and the like). The formulations may include spreader-sticker adjuvants, stabilizing agents, other additives, or surfactants. Liquid formulations may be aqueous-based or non-aqueous and employed as foams, suspensions, emulsifiable concentrates, or the like. The ingredients may include rheological agents, surfactants, emulsifiers, dispersants, or polymers.

In certain embodiments, the compositions described herein may be used in conjunction with other treatments such as cryoprotectants, surfactants, detergents, soaps, dormant oils, polymers, and/or time-release or biodegradable carrier formulations that permit long-term dosing of a target area following a single application of the formulation.

The compositions as described herein may also be used in consecutive or simultaneous application to a plant population or an environmental site singly or in combination with one or more additional treatments, such as treatment with insecticides, pesticides, chemicals, fertilizers, or other compounds.

The composition as described herein will in certain embodiments also include one or more carriers, preferably one or more agriculturally acceptable carriers. In one embodiment the carrier, such as an agriculturally acceptable carrier, can be solid or liquid. Carriers useful herein include any substance typically used to formulate agricultural composition.

In one embodiment the agriculturally acceptable carrier maybe selected from the group comprising fillers, solvents, excipients, surfactants, suspending agents, spenders/stickers (adhesives), antifoaming agents, dispersants, wetting agents, drift reducing agents, auxiliaries, adjuvants or a mixture thereof.

Compositions as described herein may be formulated as, for example, concentrates, solutions, sprays, aerosols, immersion baths, dips, emulsions, wettable powders, soluble powders, suspension concentrates, dusts, granules, water dispersible granules, microcapsules, pastes, gels and other formulation types by well-established procedures. These procedures include mixing and/or milling of the active ingredients with agriculturally acceptable carrier substances, such as fillers, solvents, excipients, surfactants, suspending agents, speaders/stickers (adhesives), antifoaming agents, dispersants, wetting agents, drift reducing agents, auxiliaries and adjuvants.

In one embodiment solid carriers include but are not limited to mineral earths such as silicic acids, silica gels, silicates, talc, kaolin, attapulgus clay, limestone, lime, chalk, bole, loess, clay, dolomite, diatomaceous earth, aluminas calcium sulfate, magnesium sulfate, magnesium oxide, ground plastics, fertilizers such as ammonium sulfate, ammonium phosphate, ammonium nitrate, and ureas, and vegetable products such as grain meals, bark meal, wood meal, and nutshell meal, cellulosic powders and the like. As solid carriers for granules the following are suitable: crushed or fractionated natural rocks such as calcite, marble, pumice, sepiolite and dolomite; synthetic granules of inorganic or organic meals; granules of organic material such as sawdust, coconut shells, corn cobs, corn husks or tobacco stalks; kieselguhr, tricalcium phosphate, powdered cork, or absorbent carbon black; water soluble polymers, resins, waxes; or solid fertilizers. Such solid compositions may, if desired, contain one or more compatible wetting, dispersing, emulsifying or colouring agents which, when solid, may also serve as a diluent. In one embodiment the carrier may also be liquid, for example, water; alcohols, particularly butanol or glycol, as well as their ethers or esters, particularly methylglycol acetate; ketones, particularly acetone, cyclohexanone, methylethyl ketone, methylisobutylketone, or isophorone; petroleum fractions such as paraffinic or aromatic hydrocarbons, particularly xylenes or alkyl naphthalenes; mineral or vegetable oils; aliphatic chlorinated hydrocarbons, particularly trichloroethane or methylene ‘ chloride; aromatic chlorinated hydrocarbons, particularly chlorobenzenes; water-soluble or strongly polar solvents such as dimethylformamide, dimethyl sulfoxide, or N-methylpyrrolidone; liquefied gases; or the like or a mixture thereof.

In one embodiment surfactants include nonionic surfactants, anionic surfactants, cationic surfactants and/or amphoteric surfactants and promote the ability of aggregates to remain in solution during spraying.

Spreaders/stickers promote the ability of the compositions as described herein to adhere to plant surfaces. Examples of surfactants, spreaders/stickers include but are not limited to Tween and Triton (Rhom and Hass Company), Deep Fried™, Fortune®, Pulse, C. Daxoil®, Codacide Oil®, D-C. Tate®, Supamet Oil, Bond®, Penetrant, Glowelt® and Freeway, Citowett®, Fortune Plus™, Fortune Plus Lite, Fruimec, Fruimec lite, alkali metal, alkaline earth metal and ammonium salts of aromatic sulfonic acids, e.g., ligninsulfonic acid, phenolsulfonic acid, naphthalenesulfonic acid and dibutylnaphthalenesulfonic acid, and of fatty acids, alkyl and alkylaryl sulfonates, and alkyl, lauryl ether and fatty alcohol sulfates, and salts of sulfated hexadecanols, heptadecanols, and octadecanols, salts of fatty alcohol glycol ethers, condensation products of sulfonated naphthalene and naphthalene derivatives with formaldehyde, condensation products of naphthalene or naphthalenesulfonic acids with phenol and formaldehyde, polyoxyethylene octylphenol ethers, ethoxylated isooctylphenol, ethoxylated octylphenol and ethoxylated nonylphenol, alkylphenol polyglycol ethers, tributylphenyl polyglycol ethers, alkylaryl polyether alcohols, isotridecyl alcohol, fatty alcohol ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and methyl cellulose. Where selected for inclusion, one or more agricultural surfactants, such as Tween are desirably included in the composition according to known protocols.

Wetting agents reduce surface tension of water in the composition and thus increase the surface area over which a given amount of the composition may be applied. Examples of wetting agents include but are not limited to salts of polyacrylic acids, salts of lignosulfonic acids, salts of phenolsulfonic or naphthalenesulfonic acids, polycondensates of ethylene oxide with fatty alcohols or fatty acids or fatty esters or fatty amines, substituted phenols (particularly alkylphenols or arylphenols), salts of sulfosuccinic acid esters, taurine derivatives (particularly alkyltaurates), phosphoric esters of alcohols or of polycondensates of ethylene oxide with phenols, esters of fatty acids with polyols, or sulfate, sulfonate or phosphate functional derivatives of the above compounds.

In one embodiment the preferred method of applying the composition as described herein is to spray a dilute or concentrated composition by handgun or commercial airblast.

As described above, the compositions as described herein may be used alone, or administered in combination with one or more other agricultural treatments, including pesticides, insecticides, acaricides, fungicides, bactericides, herbicides, antibiotics, antimicrobials, nemacides, rodenticides, entomopathogens, pheromones, attractants, plant growth regulators, plant hormones, insect growth regulators, chemosterilants, microbial pest control agents, repellents, viruses, phagostimulents, plant nutrients, plant fertilisers and biological controls. When used in combination with other agricultural treatments the administration of the compositions or formulations may be separate, simultaneous or sequential. Specific examples of these agricultural treatments are known to those skilled in the art, and many are readily commercially available.

Examples of plant nutrients include but are not limited to nitrogen, magnesium, calcium, boron, potassium, copper, iron, phosphorus, manganese, molybdenum, cobalt, boron, copper, silicon, selenium, nickel, aluminum, chromium and zinc.

Examples of antibiotics include but are not limited to oxytetracyline and streptomycin.

Examples of fungicides include but are not limited to the following classes of fungicides: carboxamides, benzimidazoles, triazoles, hydroxypyridines, dicarboxamides, phenylamides, thiadiazoles, carbamates, cyano-oximes, cinnamic acid derivatives, morpholines, imidazoles, beta-methoxy acrylates and pyridines/pyrimidines.

Further examples of fungicides include but are not limited to natural fungicides, organic fungicides, sulphur-based fungicides, copper/calcium fungicides and elicitors of plant host defences.

Examples of natural fungicides include but are not limited to whole milk, whey, fatty acids or esterified fatty acids.

Examples of organic fungicides include but are not limited to any fungicide which passes an organic certification standard such as biocontrol agents, natural products, elicitors (some of may also be classed as natural products), and sulphur and copper fungicides (limited to restricted use). An example of a sulphur-based fungicide is Kumulus™ DF (BASF, Germany). An example of a copper fungicide is Kocide® 2000 DF (Griffin Corporation, USA).

Examples of elicitors include but are not limited to chitosan, Bion™, BAB A (DL-3-amino-n-butanoic acid, 3-aminobutyric acid) and Milsana™ (Western Farm Service, Inc., USA).

In some embodiments non-organic fungicides may be employed. Examples of nonorganic fungicides include but are not limited to Bravo™ (for control of PM on cucurbits); Supershield™ (Yates, NZ) (for control of Botrytis and PM on roses); Topas® 200EW (for control of PM on grapes and cucurbits); Flint™ (for control of PM on apples and cucurbits); Amistar® WG (for control of rust and PM on cereals); and Captan™, Dithane™, Euparen™, Rovral™, Scala™, Shirlan™, Switch™ and Teldor™ (for control of Botrytis on grapes).

Examples of pesticides include but are not limited to azoxystrobin, bitertanol, carboxin, Cu₂O, cymoxanil, cyproconazole, cyprodinil, dichlofluamid, difenoconazole, diniconazole, epoxiconazole, fenpiclonil, fludioxonil, fluquiconazole, flusilazole, flutriafol, furalaxyl, guazatin, hexaconazole, hymexazol, imazalil, imibenconazole, ipconazole, kresoxim-methyl, mancozeb, metalaxyl, R-metalaxyl, metconazole, oxadixyl, pefurazoate, penconazole, pencycuron, prochloraz, propiconazole, pyroquilone, SSF-109, spiroxamin, tebuconazole, thiabendazole, tolifluamid, triazoxide, triadimefon, triadimenol, triflumizole, triticonazole and uniconazole.

An example of a biological control agent is the BotryZen™ biological control agent comprising Ulocladium oudemansii.

The compositions may also comprise a broad range of additives such as stablisers and penetrants used to enhance the active ingredients and so-called ‘stressing’ additives such as potassium chloride, glycerol, sodium chloride and glucose. Additives may also include compositions which assist in maintaining stability or microorganism viability (when one or more microbes are present in the composition) in long term storage, for example unrefined corn oil and so called invert emulsions.

As will be appreciated by those skilled in the art, it is important that any additives used are present in amounts that do not interfere with the effectiveness of the active agent(s).

Examples of suitable compositions including carriers, preservations, surfactants and wetting agents, spreaders, and nutrients are provided in U.S. Pat. No. 5,780,023, incorporated herein in its entirety by reference.

While formulations for foliar application are particularly contemplated, the compositions may be prepared in a number of forms. One preparation comprises a powdered form of a composition as described herein which may be dusted on to a plant or its surroundings. In a further form, the composition is mixed with a diluent such as water to form a spray, foam, gel or dip and applied appropriately using known protocols. In a presently preferred embodiment, a composition formulated as described above is mixed with water using a pressurised sprayer at about 1 gm/L, or about 1 to 3 kg/ha in no less than 1000 L water per ha.

Compositions formulated for other methods of application such as injection, rubbing or brushing, may also be used, as indeed may any known art method. Indirect applications of the composition to the plant surroundings or environment such as soil, water, or as seed coatings are also possible.

As discussed above, the concentration at which the compositions are to be applied so as to be effective control compositions may vary depending on the end use, physiological condition of the plant; type (including plant species) or number of plants to be controlled; temperature, season, humidity, stage in the growing season and the age of plant; number and type of conventional treatments (including herbicides) being applied; and plant treatments (such as leaf plucking and pruning).

Other application techniques, including dusting, sprinkling, soil soaking, soil injection, seed coating, seedling coating, aerating, misting, atomizing, fumigating, aerosolizing, and the like, are also feasible and may be required under certain circumstances. These application procedures are also well-known to those of skill in the art.

The compositions as described herein may also be formulated for preventative or prophylactic application to an area, and may in certain circumstances be applied to and around farm equipment, barns, domiciles, or agricultural or industrial facilities, and the like.

The concentration of composition which is used for environmental, systemic, topical, or foliar application will vary widely depending upon the nature of the particular formulation, means of application, environmental conditions, and degree of activity, such as the degree of biocidal activity. In certain embodiments, the active agent is present in the applied formulation at a concentration of at least about 0.01% by weight, and may be up to and including about 90% by weight. Dry formulations of the compositions will in certain embodiments be from about 0.1% to about 90% or more by weight active agent, while liquid formulations will in certain embodiments comprise from about 0.01% to about 90% or more of the active ingredient by weight. As such, a variety of formulations are preparable, including those formulations that comprise from about 5% to about 90% or more by weight of the active agent, including those formulations that comprise from about 10% to about 90% or more by weight of the active agent. Naturally, compositions comprising from about 15% to about 85% or more by weight of the active agent, and formulations comprising from about 20% to about 80% or more by weight of the active agent, are also considered to fall within the scope of the present disclosure.

The formulation described above may be administered to a particular plant or target area in one or more applications as needed, with a typical field application rate per hectare ranging on the order of from about 50 g/hectare to about 500 g/hectare of active ingredient, or alternatively, from about 500 g/hectare to about 1000 g/hectare may be utilized. In certain instances, it may even be desirable to apply the formulation to a target area at an application rate of from about 1000 g hectare to about 5000 g hectare or more of active ingredient. In fact, all application rates in the range of from about 50 g of active agent per hectare to about 10,000 g/hectare are contemplated to be useful in the management, control, or killing, of target organisms using such formulations. As such, rates of about 100 g/hectare, about 200 g/hectare, about 300 g/hectare, about 400 g hectare, about 500 g/hectare, about 600 g/hectare, about 700 g/hectare, about 800 g/hectare, about 900 g/hectare, about 1 kg/hectare, about 1.1 kg/hectare, about 1.2 kg/hectare, about 1.3 kg/hectare, about 1.4 kg/hectare, about 1.5 kg/hectare, about 1.6 kg/hectare, about 1.7 kg/hectare, about 1.8 kg/hectare, about 1.9 kg/hectare, about 2.0 kg/hectare, about 2.5 kg/hectare, about 3.0 kg/hectare, about 3.5 kg/hectare, about 4.0 kg/hectare, about 4.5 kg/hectare, about 6.0 kg/hectare, about 7.0 kg/hectare, about 8.0 kg/hectare, about 8.5 kg/hectare, about 9.0 kg/hectare, and even up to and including about 10.0 kg/hectare or greater of active agent may be utilized in certain agricultural, industrial, and domestic applications of the formulations described hereinabove.

In a further aspect the present invention relates to a method for controlling one or more plants, the method comprising applying to a plant or its surroundings a composition as described herein.

Young seedlings are typically most susceptible to damage from or growth retardation as a result of competing plants. Therefore, application of the compositions as described herein to freshly planted-out crops, prior to emergence, is contemplated, as is application on emergence.

Repeated applications at the same or different times in a crop cycle are also contemplated. The compositions as described herein may be applied either earlier or later in the season. This may be over flowering or during fruiting, or immediately prior to harvest of the desired crop or plant, or after harvest to rapidly colonise necrotic or senescing leaves, fruit, stems, machine harvested stalks and the like to prevent overgrowth of the environment after harvest of the desired crop or plant.

Application may be at a time before or after bud burst and before and after harvest. However, treatment preferably occurs between flowering and harvest. To increase efficacy, multiple applications (for example, 2 to 6 applications over the stages of flowering through fruiting) of the compositions as described herein is contemplated.

Due to the rapid uptake and translocation of the active agent, reapplication of the compositions as described herein after rain is not usually necessary, but may of course be undertaken when deemed necessary.

In the presently preferred embodiments, the compositions described herein are applied in a solution, for example as described above, using a pressurised sprayer. The plant parts should be lightly sprayed until just before run off. Applications may be made to any part of the plant and/or its surroundings, for example to the whole plant canopy, to the area in the canopy where the flowers and developing fruit are concentrated, or to the plant stem. While foliar application is typically the easiest applicative method, application via soil, water or growth media adjacent to or surrounding the roots, tubers or the like is also contemplated.

In preferred embodiments the composition is stable. As used herein, the term “stable” refers to a composition capable of supporting efficacy for several weeks, preferably about one, about two, about three, about four, preferably about five, more preferably about six months, or longer. In certain specifically contemplated embodiments, the composition is stable without a requirement for storage under special conditions, such as, for example, refrigeration or freezing.

The composition is in certain embodiments used to treat or pretreat soils or seeds, as opposed to direct application to a plant. In such embodiments, the composition may find use in plant processing materials such as protective coatings, boxes and wrappers.

Also encompassed by the present invention are plants, plant products, soils and seeds treated directly with a composition as described herein.

The invention is further described with reference to the following examples. It will be appreciated that the invention as claimed is not intended to be limited in any way by these examples.

### EXAMPLES

### Example 1: Preparation of Translocator Herbicides

This example describes the preparation and analysis of translocator herbicide compositions as described herein. Among the aims of these experiments was the preparation of dilute-able concentrated compositions comprising a translocating carbohydrate and the assessment of translocation of a natural contact herbicide to the plant root following foliar application.

The formulations tested are shown in Table 1 below.

TABLE 1
Formulations tested

| Ingre- | 1A | 1B | 1C | 1D | 1E | 1F |
|---|---|---|---|---|---|---|
| dient | % w/w | % w/w | % w/w | % w/w | % w/w | % w/w |
| Water | 20 | 40 | 20 | 10 | 10 | 10 |
| C8/C10 | 20 | 20 | 20 | 20 | 20 | 15 |
| Fatty | | | | | | |
| acid | | | | | | |
| APG810 | 20 | 20 | 40 | 30 | 28 | 35 |
| MPG | 20 | 20 | 20 | 20 | 18 | 20 |
| Trisol | 0 | 0 | 0 | 0 | 6 | 0 |
| N70 | | | | | | |
| Sucrose | 20 | 0 | 0 | 20 | 18 | 20 |
| Total | 100 | 100 | 100 | 100 | 100 | 100 |
| Com- | Almost | Cloudy, | Almost | Clear | Clear, | Very |
| ments | clear | separates | clear, | slightly | slightly | stable |
| | but then | imme- | high | viscous, | viscous. | Small |
| | sepa- | diately | viscosity | Sepa- | Sepa- | micelle. |
| | rates | | | rates | rates | |
| | | | | into two | into two | |
| | | | | phases | phases | |
| | | | | over- | over- | |
| | | | | night. | night. | |

MPG = Mono propylene glycol
APG810 = akyl polyglucoside 810 (surfactant, BASF)
Trisol N70 = Na dioctylsulphosucccinate, wetting agent.

Formulations were diluted to 1% w/w in water and applied by foliar spray to single sow thistle plants. Plants were monitored for cidal effect at 4 hours post application and again 24 hours after application. Plants were visually assessed and photographed at 24 H (data not shown).

Results

Composition 1C showed reasonable wetting, with some browning at 4 H. No further browning was observed at 24 H.

Composition 1 D showed reasonable wetting, with extensive browning and extensive limpness observed at 4 H. Significant tissue damage was observed.

Composition 1E showed reasonable wetting, with extensive browning and extensive limpness observed at 4 H. Significant tissue damage was observed.

Composition 1F showed a slower toxic effect than Composition 1 D or Composition 1E. However, no recovery or regrowth occurred after 10 to 12 days.

These data show that stable formulations of compositions described herein can be prepared and applied to plants via foliar application. Further, representative compositions provide long-lasting phytotoxic efficacy, preventing recovery and regrowth of plants to which they are applied.

### Example 2: Assessment of Translocation

This example describes the analysis of translocator herbicide compositions as described herein when applied to Scotch thistles. Among the aims of these experiments was the assessment of translocation of a marker dye to track translocation to the plant roots following foliar application.

Methods and Materials

Composition 1F from Example 1 was compared to a comparable composition lacking the fatty acid wounding agent. Compositions in which the marker dye Rhodamine B was added were used so that the depth and extent of penetration into plant tissue of the compositions could be assessed.

Additionally, compositions lacking the dye but comprising a botrydial-containing solution prepared from microfiltered liquid growing medium in which Botrytis cinerea fungus had been fermented were prepared.

For all tests the following method was used.
Thistles were chosen from greenhouse grown specimens that had similar size and vigour.
With all compositions tested, 5 grams was sprayed onto the tops and bottoms of leaves/foliage to ensure complete wetting.
Samples were monitored over a 21-day period and results recorded.
After 7 days, selected samples were removed from their potting soil and visually examined and photographed to establish if dye had penetrated the roots.
These selected samples were then observed and photographed under UV light to observe Rhodamine B dye fluorescence to determine if the dye had penetrated the roots.

The concentrates and test compositions used in this example are shown in Table 2 and Table 3 below.

TABLE 2
Concentrates

| Ingredient | 4A % | 1F % | 1% Dye solution |
|---|---|---|---|
| Water | 25 | 10 | 99 |
| APG810 | 35 | 35 | 0 |
| C8/C10 Fatty acid | 0 | 15 | 0 |
| MPG | 20 | 20 | 0 |
| Sucrose | 20 | 20 | 0 |
| Rhodamine B | 0 | 0 | 1.0 |
| Total | 100 | 100 | 100 |

MPG = Mono propylene glycol,
APG810 = akyl polyglucoside 810 (surfactant, BASF)

TABLE 3
Test compositions

| Ingredient | 4C | 4D | 4E | 4G | 4H |
|---|---|---|---|---|---|
| 1% | 2 | 2 | 2 | 0 | 0 |
| Rhodamine B | | | | | |
| dye soln. | | | | | |
| 4A | 0 | 2 | 0 | 0 | 2 |
| 1F | 0 | 0 | 2 | 0 | 0 |
| water | 98 | 96 | 96 | 0 | 0 |
| Botrytis | 0 | 0 | 0 | 100 | 98 |
| extract | | | | | |
| Total | 100 | 100 | 100 | 100 | 100 |

Results

Composition 4C (the dye control composition) showed no sign of wilting or other toxic effects after 7 days. Very limited penetration of the dye to the roots was observed visually and under UV light.

Composition 4 D showed some wilting and curling of leaves after 7 days. Examination under UV light showed that the dye had penetrated deeply into most and fully into some roots.

Composition 4E showed good wetting, with wilting observed at 24 hours. Complete wilting of all foliage was observed at 7 days. Further, no recovery was observed even after 1 month. The roots were too badly decayed to determine if dye had penetrated into the roots.

Composition 4G showed no sign of wilting or other toxic effects after 7 days, although limited and slight browning and curling on growing leaf tips was observed.

Composition 4H showed good wetting, with more extensive browning and curling on growing leaf tips was observed at 7 days compared to composition 4G.

These data show that translocation of agents to the roots using foliarly-applied compositions as described herein can be achieved. Further, representative compositions comprising a Botrytis extract provide long-lasting phytotoxic efficacy, preventing recovery and regrowth of plants to which they are applied.

### Example 3: Assessment of Herbicidal Efficacy

This example describes the analysis of the herbicidal efficacy of translocator herbicide compositions as described herein when applied to catnip.

Methods and Materials

Catnip (Nepeta cataria) is known to be a fairly difficult to control plant with rapid recovery after trauma which allows for easy observation of herbicidal effects.

The experiments in this example were done with compositions comprising or lacking fatty acids, with the sterile botrytis extract described in Example 2 above so that the effects could be compared.

For all tests the following method was used.
Catnip seedlings were sprayed with 10 ml of test composition per plant to ensure complete coverage of foliage;
Plants were monitored after 3 hours and every 24 hours thereafter;
Visual assessments and photographic records were made.

The test compositions used in this example are shown in Table 4 below.

TABLE 4
Test compositions

| Ingredient | 5A | 5B | 5C | 5D | 5E |
|---|---|---|---|---|---|
| water | 0 | 0 | 98 | 98 | 0 |
| Growth media | 100 | 0 | 0 | 0 | 0 |
| (control) 4A | | | | | |
| Botrytis | 0 | 100 | 0 | 0 | 98 |
| extract | | | | | |
| 4A | 0 | 0 | 2 | 0 | 0 |
| 1F | 0 | 0 | 0 | 2 | 2 |
| Total | 100 | 100 | 100 | 100 | 100 |

Results

Composition 5A (the growth media control composition) showed no sign of wilting or other toxic effects at any timepoint.

Composition 5B showed no wilting but some slight browning of leaf tips after 3 days.

Composition 5C showed no wilting but some slight browning of leaf tips after 3 days.

Composition 5 D showed extensive browning and curling on leaves at 20 hours.

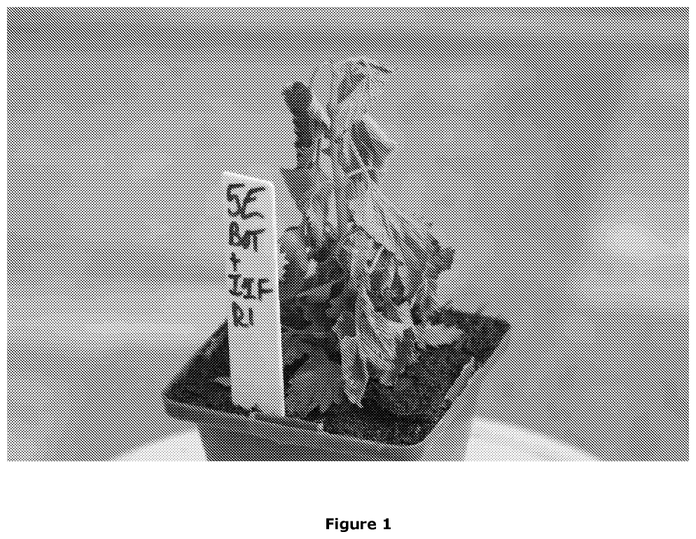

Composition 5E showed complete browning and wilting of the entire plant at 20 hours, and collapse within 24 hours (see FIG. 1).

Notably, the roots of plants to which composition 5E was applied were completed decayed at 3 weeks after application. In contrast, the roots of plants to which composition 5 D was applied were unaffected at 3 weeks, and previously browned foliage had recovered.

These data show that translocation of agents to the roots using foliarly-applied compositions as described herein can be achieved. Further, representative compositions comprising a Botrytis extract provide long-lasting phytotoxic efficacy, preventing recovery and regrowth of plants to which they are applied, even when applied to plants well-known to be challenging to control.

### Example 4: Assessment of Herbicidal Efficacy

This example describes the analysis of the translocation efficacy of compositions as described herein when applied to sunflowers. Among the aims of these experiments was the assessment of translocation of a marker dye to track translocation to the plant roots following foliar application.

Methods and Materials

Formulation 4A from Example 2 was used as the basis for various compositions in which the translocating efficacy of various carbohydrates could be compared. All test compositions were prepared with the marker dye Rhodamine B so that the depth and extent of penetration into plant tissue of the compositions could be assessed.

For all tests the following method was used.
The formulations were combined with Rhodaminee B dye compositions after diluting with water.
The area of the sunflower plants below the foliage was masked from the direct spray of compositions using parafilm. Sunflower seedlings were used as these plants have long stems and therefore a long distance for translocation to the roots.
Test compositions were applied at a rate of 10 mL per 5-6 plants.
After 5 days the extent of the dye translocation was determined by observation of different parts of the plant (roots, stems just above the ground) under natural and UV light.

The concentrates and test compositions used in this example are shown in Table 5 and Table 6 below.

TABLE 5
Concentrates

| Ingredient | 4A | 7A | 7B | 7C |
|---|---|---|---|---|
| Water | 25 | 25 | 25 | 25 |
| APG810 | 35 | 35 | 35 | 35 |
| MPG | 20 | 20 | 20 | 20 |
| Sucrose | 20 | 0 | 0 | 0 |
| Multodextrin | 0 | 20 | 0 | |
| DE10 | | | | |
| Multodextrin | 0 | 0 | 20 | |
| DE30 | | | | |
| Dextrose | 0 | 0 | 0 | 20 |
| monohydrate | | | | |
| Total | 100 | 100 | 100 | 100 |

MPG =Mono propylene glycol, APG810 =akyl polyglucoside 810 (surfactant, BASF)

TABLE 6
Test compositions

| Ingredient | 10A | 10B | 10C | 10D | 10E |
|---|---|---|---|---|---|
| 1% | 4 | 4 | 4 | 4 | 4 |
| Rhodannine B | | | | | |
| dye soln. | | | | | |
| 4A | 0 | 2 | 0 | 0 | 2 |
| 7A | 0 | 0 | 2 | 0 | 0 |
| 7B | 0 | 0 | 0 | 2 | 0 |
| 7C | 0 | 0 | 0 | 0 | 2 |
| water | 96 | 94 | 94 | 94 | 94 |
| Total | 100 | 100 | 100 | 100 | 100 |

Results

Composition 10A (the dye control composition) showed no penetration of the dye to the roots by visual inspection or under UV light. No evidence of dye was observed in stem cross sections.

Composition 10B showed extensive penetration of the dye to the roots by visual inspection and under UV light. Red colouration was visible within the roots within 2 hours of foliar application. Red colouration and significant fluorescence under UV light was observed in stem cross sections, with localisation to the phloem clearly visible.

Composition 10C showed some colouration of the roots indicating limited penetration of the dye to the roots, with little fluorescence observed in the roots under UV light.

Composition 10 D showed slightly greater colouration of the roots than 10C, indicating slightly less limited penetration of the dye to the roots, with slightly greater fluorescence observed in the roots under UV light.

Composition 10E showed significant penetration of the dye to the roots by visual inspection and under UV light, indicating only slightly lower translocation that 10B. Red colouration and significant fluorescence under UV light was observed in stem cross sections, with localisation to the phloem clearly visible.

Notably, sucrose- and dextrose-containing compositions described herein are able to rapidly and efficiently translocate active agents with which they are formulated to the stems and roots of plants to which they are applied via plant foliage.

### Example 5: Assessment of Herbicidal Efficacy

This example describes further analysis of the herbicidal efficacy of translocator herbicide compositions as described herein when applied to catnip. Among the aims of these experiments was an herbicidal assessment of various phytotoxin for use in compositions contemplated herein, and an assessment of the herbicidal efficacy of different concentrations of the botrydial-comprising extract when present in a composition as contemplated herein.

Methods and Materials

Formulation 1F from Example 1 was used as the basis for various compositions in which other components of the composition were varied.

For all tests the method described in Example 3 above was used. The test compositions used in this example are shown in Table 7 below.

TABLE 7
Test compositions

| Ingre- | | | | | | | | | |
|---|---|---|---|---|---|---|---|---|---|
| dient | 11A | 11B | 11C | 11D | 11E | 11F | 11G | 11H | 11I |
| water | 98 | 0 | 0 | 88 | 87.9 | 87.9 | 87.8 | 97.9 | 99.8 |
| Botrytis | 0 | 98 | 100 | 10 | 10 | 10 | 10 | 0 | 0 |
| extract | | | | | | | | | |
| 1F | 2 | 2 | 0 | 2 | 2 | 2 | 2 | 2 | 0 |
| Lipase | 0 | 0 | 0 | 0 | 0.1 | 0 | 0.1 | 0.1 | 0.1 |
| Cellu- | 0 | 0 | 0 | 0 | 0 | 0.1 | 0.1 | 0.1 | 0.1 |
| lase | | | | | | | | | |
| Total | 100 | 100 | 100 | 100 | 100 | 100 | 100 | 100 | 100 |

Results

Composition 11C showed some initial wilting with very rapid recovery.

Composition 11B caused rapid and irreversible toxic effects.

Composition 11 D caused some wilting, but not as much as observed with composition 11B, a comparable formulation having a higher concentration of Botrytis extract.

Composition 11E showed comparable wilting to that observed with composition 11 D.

Composition 11F exhibited a very rapid wilting effect.

Composition 11G showed very good browning and wilting after 24 hours.

Composition 11H showed similar, but not quite as pronounced, results to composition 11G.

Composition 11I showed some wilting, but after 24 hours the persistent phytotoxic effects were limited.

These data show that translocation of herbicidal agents to the roots using foliarly-applied compositions as described herein can be achieved. Further, representative compositions comprising a Botrytis extract provide long-lasting phytotoxic efficacy, preventing recovery and regrowth of plants to which they are applied.

### Example 6: Synergistic Effects of Translocators and Herbicide

This example describes the analysis of the efficacy of herbicide compositions as described herein when applied to catnip plants. Among the aims of these experiments was an assessment of herbicide efficacy and of possible synergistic efficacy evidenced by the formulations.

Methods and Materials

In this example, the commercially available non-selective contact herbicide Buster® (200 g/litre glufosinate-ammonium, BASF) was used to treat catnip plants in combination with various translocating concentrated compositions as described herein. Herbicidal efficacy was assessed essentially as described in the Examples above.

For all tests the following method was used.
Catnip plants were grown from seed in the laboratory in rockwool using the same nutrient solutions applied at the same intervals to the rockwool.
   The catnip plants were grown to a height of 40-50 cm.
   Treatment compositions were prepared.
   Compositions were applied using a spray bottle. The amount of composition sprayed on each bottle was measure by weighing the bottle before and after spraying.
   Plants were monitored daily.

The compositions and amounts of the test compositions used in this example are shown in Tables 8 and 9.

TABLE 8
Test compositions

| Ingre- | | | | | | |
|---|---|---|---|---|---|---|
| dients | A | B | C | D | E | F |
| Buster (mL) | 5 | 5 | 5 | — | — | — |
| 4A (mL) | — | 2.5 | — | — | 2.5 | — |
| 1F (mL) | — | — | 2.5 | — | — | 2.5 |
| Water | Up to | Up to | Up to | 1 L | Up to | Up to |
| | 1 L | 1 L | 1 L | | 1 L | 1 L |

TABLE 9
Amount of composition applied per plant

| | | Amount applied (g) |
|---|---|---|
| Buster | A1 | 40.6 |
| | A2 | 37.6 |
| Buster + 4A | B1 | 47.3 |
| | B2 | 46.7 |
| Buster + 1F | Cl | 29.6 |
| | C2 | 24.5 |
| Water | D1 | 6.3 |
| | D2 | 15.6 |
| 4A | E1 | 33.0 |
| | E2 | 29.4 |
| 1F | F1 | 39.3 |
| | F2 | 12.5 |

Results

On day 0 and before application of the treatment, all the plants were healthy and did not present any signs of disease.

Plants to which Buster® only was applied showed burning and wilting at day 20. Blooming and significant regrowth was observed at day 30.

Plants to which Buster+4A was applied showed burning and wilting at day 30. Regrowth was minimal, but more substantial than the regrowth observed on Buster+1F plants.

Plants to which Buster+1F was applied showed substantial burning and wilting at day 20, with burns present on the stems as well as on foliage. At 30 days, the leaves had dried up and were starting to fall from the plant, the stem was damaged, and regrowth was just apparent.

These data show that the addition of translocator concentrate (with or without fatty acid) improved the browning and wilting efficacy of the herbicide, and both delayed and negatively impacted blooming and regrowth.

### Example 7: Combined Effects of Surfactant and Botrytis cinerea on Catnip Plants

This example describes the analysis of the efficacy of herbicide compositions as described herein when applied to catnip plants. Among the aims of these experiments was an assessment of herbicide efficacy of formulations in which an extract from Botrytis cinerea comprising one or more phytotoxic, cell macerating metabolites was present, and an assessment of whether the translocation formulations described herein were effective to render systemic the otherwise highly localised action of the Botrytis cinerea phytotoxic extract.

Methods and Materials

The experiment was designed to observe the combined effect of Botrytis cinerea formulated with anionic and cationic surfactants on catnip plants.

For all tests the following method was used.
Catnip plants were obtained from a local supplier.
Catnip plants measure approximately 10 cm.
Botrytis cinerea composition was harvested and centrifuged at 3 000 rpm for 10 min followed by filtration through 0.22 μm filter prior to final formulation with translocation composition comprising various surfactants.
Treatment compositions were prepared with a ratio of 2% surfactant-comprising concentrate and 98% Botrytis filtrate.
The compositions were applied using an airbrush at a rate of 6 mL to each plant.
After 12 hours and 24 hours the plants were inspected for any signs of metabolite actions. Plants were monitored for a total of 31 days, with photos taken on days 14 and 31 to show the impact of the treatment on the plants.

The formulation details for the test compositions can be found in tables 10-12 below.

TABLE 10
Concentrate comprising anionic surfactant

| Ingredients | % W/W |
|---|---|
| Fatty acids | 15 |
| SLES (3NS70) | 35 |
| MPG | 20 |
| Sucrose | 20 |
| Water | 10 |
| Total | 100 |

TABLE 11
Concentrate comprising cationic surfactant

| Ingredients | % (W/W) |
|---|---|
| Fatty acid | 15 |
| MPG | 20 |
| Sucrose | 20 |
| Benzalkonium chloride | 35 |
| Water | 10 |
| Total | 100 |

TABLE 12
Test compositions

| Ingredients | A | B | C | D |
|---|---|---|---|---|
| B. cinerea | 98 | 98 | 100 | — |
| Cationic surfactant concentrate | 2 | — | — | — |
| Anionic surfactant concentrate | — | 2 | — | — |
| Water | — | — | — | 100 |

Results

Catnip plants treated with Botrytis filtrate combined with a concentrate comprising cationic surfactant (composition A) showed presence of blights and chlorosis at day 14 and significant wilting and browning of leaves at day 31.

Catnip treated with Botrytis filtrate combined with a concentrate comprising anionic surfactant (composition B) showed presence of blights at day 14 and significant wilting and browning of leaves at day 31

Catnip treated with Botrytis filtrate by itself showed only local impact at day 14. After the wilting phase plant health was recovered.

These data show that
When formulated with a Botrytis filtrate, concentrate compositions as described herein having either a cationic surfactant or an anionic surfactant both gave good herbicidal control, with significant wilting and browning of the leaves.
The herbicidal composition comprising a cationic surfactant gave a faster, more severe initial phytotoxic effect than that comprising an anionic surfactant.
Botrytis filtrate by itself had a slower effect on the catnip and after a wilting phase plant health was recovered.
Cationic surfactants and anionic surfactants, like the non-ionic alkyl polyglucoside surfactants used in the experiments described in Examples 1 to 6 above, are effective in supporting translocation and herbicidal efficacy of the compositions described herein, and are applicable for use in circumstances where botanical provenance and/or biodegradability is not of concern.

### Example 8: Translocation of Plant Nutrients

This example describes the analysis of the efficacy of translocation of plant nutrients using a translocating composition as described herein. Among the aims of these experiments was to assess whether a mineral composition could be transported rapidly into and within the plant, so as to enable use in foliar fertilising.

Methods and Materials

Essentially, small plants were treated with different compositions comprising Calcium ions, with and without translocators, and the differences in the amount of calcium translocated were measured.

For all tests the following method was used.
Sunflower plants were grown from seed in the laboratory in rockwool using the same nutrient solutions applied at the same intervals to the rockwool.
The sunflower plants were grown to a height of approximately 30 cm at which stage they had developed a straight stalk with a head of foliage at a distance of at least 20 cm from the point of contact with the rockwool support.
Treatment compositions were prepared. Each composition contained the same quantity of dye which was used to ensure that complete coverage of the foliage was achieved and to act as an indicator to determine the presence and amount of penetration, if any.
The plants were masked before spraying using parafilm to prevent contact with the stems or growth media and placed into clear plastic pots so that roots could be observed. The compositions were applied to the foliage of the plants using an airbrush at a rate of 5 ml per plant.
After 12 hours and 24 hours the plants were inspected for any signs of dye transfer to the roots, stems, etc.
After 24 hours the plants were cut through the stems 1 cm above the ‘ground’ level.
Cross cut and longitudinal sections of the stem were cut and then placed onto microscope slides for inspection in the wet state using conventional compound and stereoscopic microscopes.
The samples were dried between layers of Whatman no. 1 filter paper and glass slides to keep them flat.
The dried samples were analysed using a scanning electron microscope (SEM).
An X-ray Microanalysis technique called Scanning Electron Microscopy with Energy Dispersive Spectrometry (SEM/EDS) was used to determine the calcium content of different parts of the sample to assess if calcium uptake had indeed occurred.

The formulation details of the test compositions used in this example is shown in tables 13 and 14.

TABLE 13
Translocator composition 4A

| Ingredient | % W/W |
|---|---|
| Water | 25.00 |
| Alkyl polyglucoside C8 to C10 | 35.00 |
| Monopropylene glycol | 20.00 |
| Sucrose | 20.00 |
| Total | 100.00 |

TABLE 14
Test composition (per plant).

| | % W/W | | | | |
|---|---|---|---|---|---|
| Ingredient | 65A | 65B | 65C | 65D | 65E |
| Water | 93.00 | 91.00 | 91.00 | 89.00 | 98.00 |
| Calcium Chloride | 5.00 | 5.00 | 5.00 | 5.00 | — |
| GLDA | — | 2.00 | — | 2.00 | — |
| 4A | — | — | 2.00 | 2.00 | — |
| 1% Rhodaminee B solution | 2.00 | 2.00 | 2.00 | 2.00 | 2.00 |
| Total | 100.00 | 100.00 | 100.00 | 100.00 | 100.00 |

Results

Composition 65A alone did not show any signs of dye translocation. Similarly, no dye transfer was observed with composition 65B. Cross sections of calcium chloride compositions without translocator composition, compositions 65A and 65B, did not show any evidence of dye translocation.

Samples to which the calcium/dye compositions comprising the translocator composition had been applied showed pink discoloration of vascular bundles in the cross section and the longitudinal sections. This was especially evident in one of the replicates to which composition 65 D had been applied.

The roots of plants to which composition 65C had been applied showed red discolouration within 8 hours of treatment, clearly establishing that the dyed composition had been rapidly translocated to the roots.

All samples containing calcium chloride caused wilting of the treated foliage. No wilting was seen with composition 65E. This suggests that rather than being phytobeneficial, high levels of calcium chloride may cause phytotoxic effects.

SEM/EDS analysis showed that the calcium-containing composition comprising the translocation composition was effectively uptaken and transported by the plants. The results of this testing are shown in Table 15 below.

TABLE 15
Calcium and chlorine SEM/EDS testing.

| Component | 65A | 65B | 65C | 65D | 65E |
|---|---|---|---|---|---|
| Calcium: Xylem | 0.3 to 0.7 | 0.5 to 0.9 | 2.9 to 3.5 | n.d. | 1.0 |
| Calcium: Phloem | 1.3 to 3.3 | 0.6 to 0.9 | 4.4 to 4.5 | n.d. | 1.0 |
| Calcium: Whole/average | <2.0 | <2.0 | 4.0 | n.d. | 1.1 |
| Chlorine: Xylem | 0.6 to 0.9 | 0.1 to 0.2 | 0.9 to 1.2 | n.d. | 0.4 |
| Chlorine: Phloem | 1.0 to 1.2 | 0.2 to 0.4 | 1.8 to 2.4 | n.d. | 0.5 |
| Chlorine: Whole/average | <1.0 | <0.4 | <1.5 | n.d. | 0.4 |

Plants to which the control composition 65E was applied showed a calcium content of approximately 1% in all parts of the samples tested, presumably representing a fairly uniform distribution throughout the plant.

Application of composition 65A resulted in a slight increase of the calcium in the phloem, but in no other parts of the plant.

Composition 65B did not show any increase in calcium levels within the plant.

Composition 65C showed a significant increase in the calcium and the chlorine content in the plants to which it was applied, with a greater concentration of each ion present in the phloem.

These data show that
Some calcium is translocated from the foliage when spraying plants with a solution of calcium chloride, but this is limited and slow. Evidence is the low Ca level in the xylem and higher level in the phloem. The average level is not significantly higher than the plant treated with plain water.
Addition of GLDA did not substantially improve calcium uptake.
More calcium is translocated using the concentrated translocation composition 4A. Levels are higher throughout the crosscut section of the plants tested with less difference between xylem and phloem than in samples treated without translocator.
The concentrated translocation compositions presented herein are capable of increasing the translocation of mineral nutrients. The applicants believe, without wishing to be bound by any theory, that different plants may respond differently to the translocation compositions described herein, given their anatomy and physiology, for example, their differing transpiration rates, waxy leaves or cuticles, habit, and the like, but that translocation compositions as described herein will be effective to improve translocation through the plant of mineral nutrients applied via foliar application in a wide variety of plants.

The entire disclosures of all applications, patents and publications cited above and below, if any, are herein incorporated by reference.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope as described herein and without diminishing its attendant advantages. It is therefore intended that such changes and modifications be included within the present invention.

The invention may also be said broadly to consist in the parts, elements and features referred to or indicated in the specification of the application, individually or collectively, in any or all combinations of two or more of said parts, elements or features.

Aspects as described herein have been described by way of example only, and it should be appreciated that variations, modifications and additions may be made without departing from the scope as described herein, for example when present the invention as defined in the indicative claims. Furthermore, where known equivalents exist to specific features, such equivalents are incorporated as if specifically referred in this specification.

1. An agriculturally acceptable composition for application to a plant or its surroundings, the composition comprising, consisting essentially of, or consisting of
i) one or more carbohydrates;
ii) one or more active agents selected from the group comprising one or more phytotoxins, one or more nutrients, and one or more organic molecules; and
iii) optionally one or more surfactants; and
iv) optionally one or more wounding agents;
wherein the one or more carbohydrates is present in an amount or at a concentration at application to the plant or its surroundings effective to increase systemic distribution of the one or more active agents in the plant beyond the systemic distribution achieved in the absence of the carbohydrate.

2. The composition of claim 1, comprising, consisting essentially of, or consisting of
i) one or more carbohydrates;
ii) one or more active agents selected from the group comprising one or more phytotoxins, one or more nutrients, and one or more organic molecules; and
iii) one or more surfactants; and
iv) optionally one or more wounding agents.

3. The composition of claim 1 comprising one or more wounding agents.

4. The composition of claim 1 wherein at least a proportion of the one or more of the carbohydrates present in the composition and at least a proportion of the one or more active agents are present as a complex, as an inclusion complex, or are ionically bound.

5. An agriculturally acceptable concentrated composition suitable for dilution prior to application, the concentrated composition comprising, consisting essentially of, or consisting of:
i) at least about 5% w/w one or more carbohydrates;
ii) at least about 5% w/w one or more surfactants;
iii) at least about 5% w/w one or more wounding agents; and
iv) optionally at least about 5% w/w humectants.

6. The composition of claim 5, wherein the composition comprises, consists essentially of, or consists of
i) from about 5% w/w to about 50% w/w carbohydrate;
ii) from about 5% w/w to about 50% w/w aqueous solvent, such as water;
iii) from about 5% w/w to about 30% w/w wounding agent;
iv) from about 5% w/w to about 50% w/w surfactant; and
v) optionally from about 5% w/w to about 30% w/w humectant; or
vi) from about 15% w/w to about 30% w/w carbohydrate;
vii) from about 10% w/w to about 50% w/w aqueous solvent, such as water;
viii) from about 15% w/w to about 30% w/w wounding agent;
ix) from about 15% w/w to about 50% w/w surfactant; and
x) optionally from about 10% w/w to about 30% w/w humectant; or
xi) from about 15% w/w to about 25% w/w carbohydrate;
xii) from about 10% w/w to about 40% w/w aqueous solvent, such as water;
xiii) from about 15% w/w to about 25% w/w wounding agent;
xiv) from about 20% w/w to about 50% w/w surfactant; and
xv) optionally from about 10% w/w to about 25% w/w humectant; or
xvi) from about 15% w/w to about 25% w/w carbohydrate;
xvii) from about 10% w/w to about 25% w/w aqueous solvent, such as water;
xviii) from about 15% w/w to about 25% w/w wounding agent;
xix) from about 15% w/w to about 40% w/w surfactant; and
xx) optionally from about 10% w/w to about 25% w/w humectant.

7. The composition of claim 1 wherein one or more of the one or more carbohydrates is a disaccharide.

8. The composition of claim 7 wherein substantially all of the carbohydrate present is one or more disaccharides.

9. The composition of claim 7 wherein the disaccharide is selected from the group comprising sucrose, lactose, and maltose.

10. The composition of claim 5, comprising, consisting essentially of, or consisting of
i) from about 15% w/w to about 25% w/w sucrose;
ii) from about 10% w/w to about 25% w/w aqueous solvent, such as water;
iii) from about 15% w/w to about 25% w/w short or medium chain fatty acid;
iv) from about 15% w/w to about 40% w/w akyl polyglucoside; and
v) optionally from about 10% w/w to about 25% w/w propylene glycol; or
vi) from about 15% w/w to about 20% w/w sucrose;
vii) from about 10% w/w to about 20% w/w water;
viii) from about 15% w/w to about 20% w/w short or medium chain fatty acid;
ix) from about 15% w/w to about 40% w/w akyl polyglucoside; and
x) optionally from about 15% w/w to about 25% w/w propylene glycol; or
xi) about 20% w/w sucrose;
xii) about 10% w/w water;
xiii) about 15% w/w short or medium chain fatty acid;
xiv) about 35% w/w akyl polyglucoside; and
xv) optionally about 20% w/w propylene glycol; or
xvi) about 20% w/w sucrose;
xvii) about 10% w/w water;
xviii) about 15% w/w caprylic (C₈) and capric (C₁₀) fatty acids;
xix) about 35% w/w akyl polyglucoside; and
xx) optionally about 20% w/w propylene glycol.

11. The composition of claim 5, wherein the one or more phytotoxins is a biological herbicide.

12. The composition of claim 5, wherein the one or more phytotoxins is selected from the group comprising:
i) a phytotoxic microorganism selected from the group comprising Botrytis spp., Rhizopus spp., Sclerotinia minor, Mucor spp., Erwinia carotovora subsp. caratovora, and Pseudomonas pp., such as Pseudomonas syringae;
ii) one or more phytotoxic agents derived from or metabolites from Botrytis spp., Rhizopus spp., Sclerotinia minor, Mucor spp., Erwinia carotovora subsp. caratovora, and Pseudomonas pp., such as Pseudomonas syringae;
iii) culture media or a culture extract from a phytotoxic microorganism selected from the group comprising Botrytis spp., Rhizopus spp., Sclerotinia minor, Mucor spp., Erwinia carotovora subsp. caratovora, and Pseudomonas pp., such as Pseudomonas syringae; and
iv) any combination of two or more of i) to iii) above.

13. The composition of claim 12, wherein the one or more phytotoxins is one or more phytotoxic metabolites of Botrytis cinerea.

14. The composition of claim 12 or 13, wherein the phytotoxin is selected from the group comprising botrydial, botcinic acid, and one or more phytotoxic polyketides.

15. The composition of claim 5, wherein the composition is formulated for foliar application.

16. The composition of claim 5, wherein the systemic distribution is distribution to the roots.

17. A method of controlling one or more plants or plant populations, the method comprising contacting the plant, plant population, or plant surroundings with a phytotoxically-effective amount of a composition comprising, consisting essentially of, or consisting of
i) one or more carbohydrates; and
ii) one or more phytotoxins;
iii) optionally one or more surfactants; and
iv) optionally one or more wounding agents;
wherein the one or more carbohydrates is present in an amount or at a concentration at application to the plant or its surroundings effective to increase systemic distribution of the one or more phytotoxins in the plant beyond the systemic distribution achieved in the absence of the carbohydrate.

18. (canceled)

19. (canceled)

20. (canceled)

21. The method of claim 17, wherein the composition is applied to the plant foliage.

22. (canceled)
